(19) United States
(12) Patent Application Publication
(10) Pub. No.: US 2025/0150494 A1
(43) Pub. Date: May 8, 2025

(54) ARTIFICIAL INTELLIGENCE-BASED WORKSPACE CONTENT GENERATION USING SOURCES OF DIGITAL ASSETS IN A MULTI-USER SEARCH AND COLLABORATION ENVIRONMENT

(71) Applicant: Bluescape Buyer LLC (dba Bluescape), Chicago, IL (US)

(72) Inventors: Antti PIIRA, San Francisco, CA (US); Rupen CHANDA, Austin, TX (US)

(73) Assignee: Bluescape Buyer LLC (dba Bluescape), Chicago, IL (US)

(21) Appl. No.: 18/936,947

(22) Filed: Nov. 4, 2024

Related U.S. Application Data
(60) Provisional application No. 63/596,066, filed on Nov. 3, 2023.
(60) Provisional application No. 63/596,072, filed on Nov. 3, 2023.
(60) Provisional application No. 63/598,904, filed on Nov. 14, 2023.
(60) Provisional application No. 63/609,086, filed on Dec. 12, 2023.

(51) Int. Cl. H04L 65/1083; G06N 20/00

(52) U.S. Cl. CPC H04L 65/1083; G06N 20/00

(57) ABSTRACT

The technology disclosed relates to a system and methods for artificial intelligence-based workspace content generation using sources of digital assets in a multi-user search and collaboration environment. The disclosed methods can include sending a portion of a spatial event map that locates events in a virtual workspace; sending data to allow the client node to display a digital asset identified by events in the spatial event map; receiving an input for a trained machine learning model wherein the input comprises the identification of a digital asset selected by a user or desired features in an artificial intelligence (AI)-based digital asset; sending the input received to the trained machine learning model; receiving the AI-based digital asset as output by the trained machine learning model; and sending the AI-based digital asset to a plurality of client nodes, allowing the client nodes to display the AI-based digital asset in respective digital displays.

### PRIORITY APPLICATION

This application claims the benefit of U.S. Provisional Patent Application No. 63/596,066 (Attorney Docket No. HAWT 1053-1), titled, “MULTI-USER INFINITE CANVAS WITH INTERLEAVED CUSTOM RENDERED OBJECTS AND BROWSER RENDERED OBJECTS,” filed on 3 Nov. 2023; U.S. Provisional Patent Application No. 63/596,072 (Attorney Docket No. HAWT 1052-1), titled, “SYSTEMS AND METHODS FOR SYNCHRONOUS AND ASYNCHRONOUS REVIEW OF 3-DIMENSIONAL MODELS IN A COLLABORATION SESSION,” filed on 3 Nov. 2023; U.S. Provisional Patent Application No. 63/598,904 (Attorney Docket No. HAWT 1051-1), titled, “ARTIFICIAL INTELLIGENCE-BASED SCENE GENERATION USING SOURCES OF DIGITAL ASSETS IN A MULTI-USER SEARCH AND COLLABORATION ENVIRONMENT,” filed on 14 Nov. 2023; and U.S. Provisional Patent Application No. 63/609,086 (Attorney Docket No. HAWT 1035-1), titled, “SYSTEMS AND METHODS FOR DEPLOYING AND OPERATING THIRD-PARTY APPLICATIONS IN A COLLABORATIVE ENVIRONMENT,” filed on 12 Dec. 2023; of which the applications are incorporated herein by reference.

### INCORPORATIONS

The following materials are incorporated by reference in this filing:
U.S. patent application Ser. No. 16/845,983 (Atty. Docket No. HAWT 1034-2), titled “Synchronous Video Content Collaboration Across Multiple Clients in a Distributed Collaboration System,” filed on Apr. 10, 2020, now issued as U.S. Pat. No. 11,178,446;
U.S. application Ser. No. 15/791,351 (Atty. Docket No. HAWT 1025-1), titled “Virtual Workspace Including Shared Viewport Markers in a Collaboration System,” filed on Oct. 23, 2017, now issued as U.S. Pat. No. 11,126,325;
U.S. application Ser. No. 14/090,830 (Atty. Docket No. HAWT 1011-2), titled “Collaboration System Including a Spatial Event Map,” filed on Nov. 26, 2013, now issued as U.S. Pat. No. 10,304,037;
U.S. application Ser. No. 15/147,576 (Atty. Docket No. HAWT 1019-2A), titled “Virtual Workspace Viewport Following in Collaboration Systems,” filed on May 5, 2016, now issued as U.S. Pat. No. 10,802,783;
Billen et al. 2019, “3D viewpoint management and navigation in urban planning: Application to the exploratory phase”, published in the Journal of Remote Sensing, 11, no. 3:236. The article is available online at <<www.mdpi.com/2072-4292/11/3/236>>;
<<en.wikipedia.org/wiki/Polygon_mesh>>;
<<en.wikipedia.org/wiki/Blend_modes>>; and
<<en.wikipedia.org/wiki/Alpha_compositing>>.

### FIELD OF INVENTION

The present technology relates to collaboration systems that enable users to actively collaborate in a virtual workspace in a collaboration session. More specifically, the technology relates to collaboration incorporating artificial intelligence-based generation of virtual workspace content.

### BACKGROUND

Collaboration systems are used in a variety of environments to allow users to contribute and participate in content generation, curation and review. Users of collaboration systems can join collaboration sessions from remote locations around the globe. The participants of a collaboration session can review, edit, curate and comment on a variety of digital asset types such as documents, slide decks, spreadsheets, images, videos, three-dimensional (3D) models, software applications, program code, user interface designs, search results from one or more sources of digital assets or search engines, etc.

The participants can independently add, delete, edit or manipulate content or digital assets in the collaboration workspace (also referred to as a canvas or a whiteboard). During a collaboration session, the participants can add a variety of content to the workspace such as images, videos, 3D models, documents, user interface designs, architectural designs, etc. The participants of a collaboration session may provide their input by adding comments and/or annotations, or write questions, or make corrections, etc. to content presented on the workspace. Digital assets in the collaboration workspace can be created based on data from a variety of disparate sources, and it is beneficial to generate new digital assets based on this data or organize said digital assets within the same workspace in a logical, efficient manner to boost productivity within the collaboration.

An opportunity arises to provide a method for artificial intelligence-based generation of workspace content using sources of digital assets in a multi-user search and collaboration environment.

### SUMMARY

A system and method for artificial intelligence-based workspace content generation using sources of digital assets in a multi-user search and collaboration environment are disclosed. The method includes sending, from a server node, at least a portion of a spatial event map that locates events in a virtual workspace at a client node in a plurality of client nodes. The spatial event map comprises a specification of a dimensional location of a viewport in the virtual workspace. The method includes sending, from the server node, data to allow the client node to display, in a screen space of a display associated with the client node, a digital asset identified by events in the spatial event map that have locations within a viewport of the client node. The method includes receiving, from the client node, an input for a trained machine learning model and a prompt. The input comprises the identification of the digital asset selected by a user and the prompt is a text-based and/or a voice-based description of desired features in an AI-based digital asset or layout of digital assets. The method includes sending, from the server node, the input received from the client node to the trained machine learning model and receiving, at the server node, the AI-based digital asset or layout of digital assets as output by the trained machine learning model. The method includes sending, from the server node, the AI-based digital asset or layout of digital assets to the plurality of client nodes, allowing the client nodes to display the AI-based digital asset or layout of digital assets in respective digital displays linked to the plurality of client nodes.

Systems which can be executed using the methods are also described herein.

Computer program products which can execute the methods presented above are also described herein (e.g., a non-transitory computer-readable recording medium having a program recorded thereon, wherein, when the program is executed by one or more processors the one or more processors can perform the methods and operations described above).

Other aspects and advantages of the present technology can be seen on review of the drawings, the detailed description, and the claims, which follow.

### BRIEF DESCRIPTION OF THE DRAWINGS

The technology will be described with respect to specific implementations thereof, and reference will be made to the drawings, which are not drawn to scale, described below.

FIG. 1 illustrates example aspects of a digital display collaboration environment.

FIG. 2 shows a collaboration server and a database that can constitute a server node.

FIG. 3 presents an example of an AI-based dashboard rendered in a virtual workspace.

FIGS. 4A, 4B, and 4C present user interface elements to initiate generation of AI-based digital assets based on prompts received from users in a collaboration session.

FIG. 5 is a simplified block diagram of a computer system, or client node, which can be used to implement the client functions or the server-side functions for sending data to client nodes in a collaboration system.

FIGS. 6A, 6B, 6C, 6D, 6E, 6F, 6G, 6H, 6I, 6J, 6K, 6L, 6M, and 6N present an example illustrating a third-party application executing in a programmable window within a virtual workspace.

FIGS. 7A, 7B, 7C and 7D present an example of rendering first-party elements and third-party elements on a workspace.

FIGS. 8A, 8B, 8C, and 8D present an example of a three-dimensional model reviewed by participants in a collaboration session.

FIG. 9 illustrates a virtual camera placed in a three-dimensional space to view a 3D object.

### DETAILED DESCRIPTION

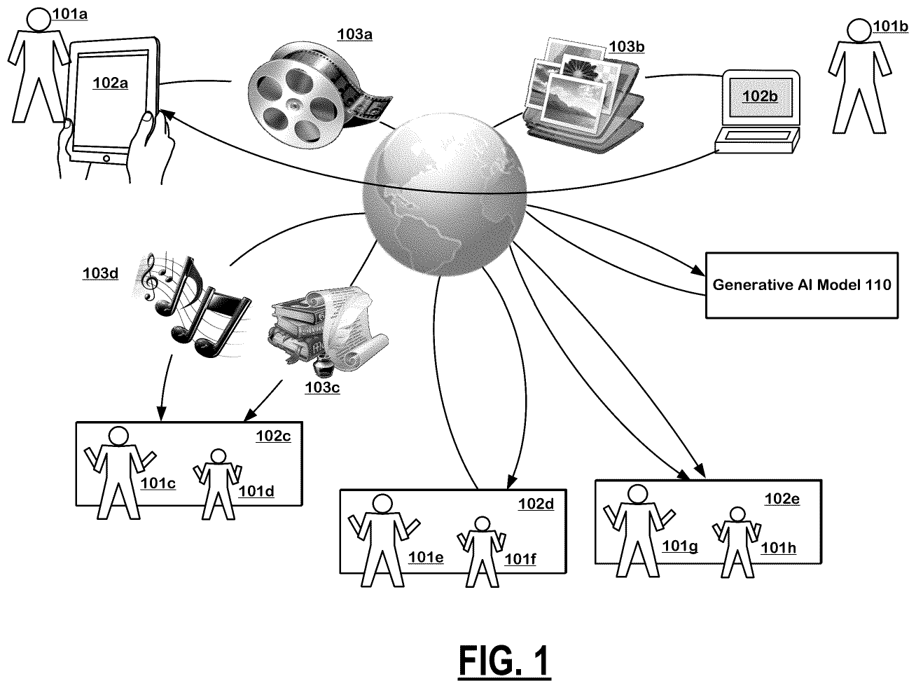

A detailed description of implementations of the present technology is provided with reference to FIGS. 1-9.

The following description is presented to enable a person skilled in the art to make and use the technology and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

Artificial Intelligence-Based Generation of Digital Assets within a Dashboard Layout

A user participating in a collaboration session can provide search keywords to allow searching of digital assets or content from multiple sources of digital assets. The technology disclosed can use one or more key-phrases for searching digital assets. A key-phrase can comprise at least one of a text-based keyword, one or more spoken words, a portion of an image, a brief description or a sentence such as taken from a document, selected lines of code from a computer program, portions of three-dimensional models, etc. The digital assets can be curated and shared with other users. The user can start a collaboration session with other users to review search results and perform further searching and curation of digital assets. Users can search for digital assets such as images, videos, documents, or text, using, from within or outside of the collaboration system, search engines e.g., Getty Images™, Shutterstock™, iStock, Giphy™, Instagram™, Twitter™, Google™ or any other digital asset management system. The digital asset may be a newly generated element (e.g., an image, video, document, text, data visualization, etc.) created by the generative AI model, based on one or more selected input digital assets (and/or a prompt) provided by a user, or a digital asset with coordinates within the virtual workspace. The digital asset may also be an existing element identified within the search results and extracted by the generative AI model for placement within a virtual workspace. The search results or an AI-generated digital asset based on the search results can be automatically placed in the virtual workspace and can be curated into different canvases based on pre-defined criteria or based on sources of search results. The digital assets and other content that is searchable by the generative AI model can include live data, such as a livestream video or other intermittently updated data, such that an AI-based digital asset based on the search content is also updatable. For example, the generative AI model may have access to raw data from which a data visualization is generated, and the data visualization can be autonomously updated by the generative AI model as the source raw data is updated.

The participants of the collaboration session may want to view the search results (such as images, 3D models, product designs, etc.) or at least a selected search result presented or arranged in dependence upon certain criteria. For example, the technology disclosed can be used to autonomously generate a collaborative Operations Center dashboard (“dashboard”) based on the user-provided prompt. Suppose that a user would like to view and collaboratively interact with a dashboard that includes a plurality of digital assets relating to a specific current event, such as an election or a natural disaster. Data and information associated with a hurricane, for example, may include forecast data (e.g., weather, climate, and hydrologic forecasts), weather radar, drone footage, emergency alerts (e.g., warnings, watches, advisories, and government orders), radio transmissions, and media outlet reporting. Furthermore, various sources of data such as the aforementioned list of hurricane data are obtained from disparate data sources like the National Weather Service, National Hurricane Center, Federal Emergency Management Agency, state and local municipalities in affected regions, and a plurality of different news networks, agencies, and aggregators. It is very time-consuming for users to manually gather data from disparate data sources and similarly inefficient to arrange and present the gathered data within a collaborative dashboard workspace. Particularly in time-sensitive emergencies like hurricanes, efficiency in gathering this information is beneficial.

The technology disclosed enables a user to provide a prompt as input to a generative AI service, and the generative AI service then processes the prompt, identifies and collects digital assets related to the prompt, and generates a collaborative dashboard within a shared workspace that presents an arrangement of the collection of digital assets. The user prompt may be text-based, voice-based, or digital-asset based. In a scenario based on the previous hurricane example, a user prompt may be a text or voice-based audio input such as “hurricane helene news and forecasts,” a Doppler radar tracking the hurricane, a news article reporting on the hurricane, and so on. In some implementations, the generative AI model has access to a digital asset management (DAM) system or other form of data repository, digital asset libraries associated with the user's institutional affiliation, and/or Internet search engines. After the generative AI model has generated the Operations Center dashboard layout within a collaborative workspace, populated with the digital assets retrieved in response to the provided prompt, multiple users are able to access the Operations Center dashboard and collaboratively interact with the digital assets within the dashboard. In many implementations, any user with the pre-requisite access permissions can interact with the dashboard to further fine-tune the presented digital assets, even if that user did not personally prompt generation of the dashboard.

In one implementation, the user can provide feedback to the generative AI model to request that the organizational layout or visual presentation of the digital assets is modified to meet certain criteria (e.g., making a particular digital asset or category of digital assets larger or more centered, or rearranging the digital assets based on a user-specified categorization schema). In another implementation, the user can select a particular digital asset and prompt the generative AI model to replace with a different digital asset, either based on similarity or optionally based on further specifics provided by the user. In yet another implementation, the user can select a particular digital asset and request that the generative AI model update the dashboard to include additional digital assets that are similar in content and/or format to the selected digital asset.

Consider the aforementioned hurricane example. Once the dashboard has been generated, a user may provide feedback to the generative AI model to replace an outdated radar image forecasting the hurricane path with a more recent version. Alternatively, the user could prompt the generative AI model to update the dashboard to only include digital assets that are less than 24 hours old. In addition to prompting the generative AI model to update or change the dashboard, users are also able to continue manually modifying the dashboard layout and digital assets within the dashboard. In another implementation, the user can prompt the generative AI model to generate a specific digital asset rather than a layout of multiple digital assets. For example, the user may want to see a graph displaying the eye pressure of the hurricane over time. In contrast to manually locating the necessary data and preparing the graph oneself, the user can provide a prompt to the generative AI model requesting that said graph is generated as a digital asset and presented within the workspace. The prompt can be a voice/text description of the desired graph, meteorological data necessary to generate the graph (e.g., within the text input, uploaded in a data file, or provided via a link to a webpage containing the necessary data), or a combination of both. Moreover, after the graph has been generated, the user may provide additional feedback to refine the parameters of the data visualization or the aesthetic format of the graph itself.

The technology disclosed allows users of the collaboration session to select one or more digital assets such as an image, a 3D model, a product design, etc. or other types of graphical objects from search results or from external DAM systems. The technology disclosed allows users to provide a text-based or voice-based prompt for generating an AI-generated digital asset or an AI-generated workspace containing one or more digital assets in a particular arrangement. The text-based prompt or voice-based prompt can include a description of the AI-based digital asset or workspace that she would like to generate including the one or more selected digital assets or portions of one or more selected digital assets from the workspace or from DAM systems. For example, the text-based prompt or the text-based input for the above example, can include, “forecast and emergency preparedness information related to hurricane helene specific to the gulf coast of Florida,” or simply “hurricane helene gulf coast Florida.” The technology disclosed can automatically generate an input to a trained machine learning model to generate an AI-based Operations Center dashboard. The entire virtual workspace may be used as the dashboard, or a subregion of the virtual workspace can be used for the dashboard. The input to the trained machine learning model can include the one or more selected digital assets and the text-based or voice-based prompt provided by the user. The output from the trained machine learning model is an AI-generated layout of curated digital assets that can be positioned in the workspace for further review and collaboration amongst the participants of the collaboration session. In some implementations, a notification is sent to one or more users indicating the generation of an AI-based asset, placement of the AI-based digital asset within the workspace, or AI-assisted modification of a digital asset within the workspace. In other implementations, the display of one or more client devices corresponding to respective participants in a collaboration session may be automatically updated, in response to a particular AI-assisted action, to force display (to some or all users) of a region of the workspace in which the AI-based asset is located.

The generative AI model is synonymously referred to herein as a trained machine learning model. The trained machine learning model may be a single model or an ensemble of models. The trained machine learning model may be a transformer or autoencoder, a graph network, a large language model, a named entity recognition model, etc. in various implementations. A user skilled in the art will recognize the machine learning model architecture, training algorithms, and learning mechanisms that fall within the scope of the technology disclosed. The following sections present some key elements of the collaboration system, followed by further details of the generative AI technology.

### Workspace

In order to support an unlimited amount of spatial information for a given collaboration session, the technology disclosed provides a way to organize a virtual space termed the “workspace”. The workspace can be characterized by a multi-dimensional and in some cases two-dimensional plane with essentially unlimited extent in one or more dimensions for example, in such a way that new content can be added to the space. The content can be arranged and rearranged in the space, and a user can navigate from one part of the space to another.

Digital assets (or objects), as described above in more detail, are arranged on the virtual workspace (or shared virtual workspace). Their locations in the workspace are important for performing the gestures. One or more digital displays in the collaboration session can display a portion of the workspace, where locations on the display are mapped to locations in the workspace. The digital assets can be arranged in canvases (also referred to as sections or containers). Multiple canvases can be placed on a workspace. The digital assets can be arranged in canvases based on various criteria. For example, digital assets can be arranged in separate canvases based on their respective source of digital asset or based on digital asset management system from where the digital asset has been accessed. The digital assets can be arranged in separate canvases based on users or participants. The search results of each user can be arranged in a separate canvas (or section). Other criteria can be used to arrange digital assets in separate canvases, for example type of content (such as videos, images, PDFs documents, etc.), category of content (such as cars, trucks, bikes, etc.).

The technology disclosed provides a way to organize digital assets in a virtual space termed as the workspace (or virtual workspace), which can, for example, be characterized by a two-dimensional (2D) plane (along X-axis and Y-axis) with essentially unlimited extent in one or both dimensions, for example. The workspace is organized in such a way that new content such as digital assets can be added to the space, that content can be arranged and rearranged in the space, that a user can navigate from one part of the space to another, and that a user can easily find needed things in the space when it is needed. The technology disclosed can also organize content on a three-dimensional (3D) workspace (along X-axis, Y-axis, and Z-axis).

### Viewport

One or more digital displays in the collaboration session can display a portion of (e.g., a dashboard within) the workspace, where locations on the display are mapped to locations in the workspace. A mapped area, also known as a viewport within the workspace is rendered on a physical screen space. Because the entire workspace is addressable using coordinates of locations, any portion of the workspace that a user may be viewing itself has a location, width, and height in coordinate space. The concept of a portion of a workspace can be referred to as a “viewport”. The coordinates of the viewport are mapped to the coordinates of the screen space. The coordinates of the viewport can be changed which can change the objects contained within the viewport, and the change would be rendered on the screen space of the display client. Details of workspace and viewport are presented in our U.S. application Ser. No. 15/791,351 (Atty. Docket No. HAWT 1025-1), titled, “Virtual Workspace Including Shared Viewport Markers in a Collaboration System,” filed on Oct. 23, 2017, now issued as U.S. Pat. No. 11,126,325, which is incorporated by reference and fully set forth herein. Participants in a collaboration session can use digital displays of various sizes ranging from large format displays of sizes five feet or more and small format devices that have display sizes of a few inches. One participant of a collaboration session may share content (or a viewport) from their large format display, wherein the shared content or viewport may not be adequately presented for viewing on the small format device of another user in the same collaboration session. The technology disclosed can automatically adjust the zoom sizes of the various display devices so that content is displayed at an appropriate zoom level.

### Spatial Event Map

Participants of the collaboration session can work on the workspace (or virtual workspace) that can extend in two dimensions (along x and y coordinates) or three dimensions (along x, y, z coordinates). The size of the workspace can be extended along any dimension as desired and therefore can considered as an “unlimited workspace”. The technology disclosed includes data structures and logic to track how people (or users) and devices interact with the workspace over time. The technology disclosed includes a so-called “spatial event map” (SEM) to track interaction of participants with the workspace over time. The spatial event map contains information needed to define digital assets and events in a workspace. It is useful to consider the technology from the point of view of space, events, maps of events in the space, and access to the space by multiple users, including multiple simultaneous users. The spatial event map can be considered (or represent) a sharable container of digital assets that can be shared with other users. The spatial event map includes location data of the digital assets in a two-dimensional or a three-dimensional space. The technology disclosed uses the location data and other information about the digital assets (such as the type of digital asset, shape, color, etc.) to display digital assets on the digital display linked to computing devices used by the participants of the collaboration session.

A spatial event map contains content in the workspace for a given collaboration session. The spatial event map defines arrangement of digital assets on the workspace. Their locations in the workspace are important for performing gestures. The spatial event map contains information needed to define digital assets, their locations, and events in the workspace. A spatial events map system maps portions of workspace to a digital display e.g., a touch enabled display. Details of workspace and spatial event map are presented in our U.S. application Ser. No. 14/090,830 (Atty. Docket No. HAWT 1011-2), titled, “Collaboration System Including a Spatial Event Map,” filed on Nov. 26, 2013, now issued as U.S. Pat. No. 10,304,037, which is incorporated by reference and fully set forth herein.

The technology disclosed can receive search results from sources of digital assets such as public or private search engines, public or private repositories of digital assets, etc. The search results can be directly placed or saved in a collaborative search space (such as the spatial event map or SEM). The search results can be arranged in canvases (or sections) that are categorized by pre-defined criteria such as sources of digital assets, categories of content, users, etc. The technology disclosed allows sharing the search results with other users by simply by inviting a user to a collaboration session. The server (also referred to as a server node or a collaboration server) sends the spatial event map or at least a portion of the spatial event map to the client node (or computing device) of a new user who joins the collaboration session using the client node. In one implementation, the collaboration server (or server node) sends a portion of the spatial event map to client nodes such that the portion of the spatial event only includes data including the search results located within the respective viewports of the client nodes. The collaboration server sends updates to the spatial event map via update events as changes to viewport are detected at respective client nodes. In one implementation, the technology disclosed includes logic to send some additional data in the spatial event map located outside of the boundaries of the viewport to improve the quality of user experience and reduce the response time from the server node when changes to viewport are made. The search results are displayed on the display screen of the new user. The data provided by the server node to the client node comprises a spatial event map identifying a log of events in the workspace. The entries within the log of events are associated with respective locations of digital assets related to (i) events in the workspace and (ii) times of the events. A particular event identified by the spatial event map can be related to the curation of a digital asset of the digital assets. Events can be generated and sent from the client nodes to the server node or from the server node to the client nodes. Events can be generated when search functionality is selected by a user on a client node. Events can be generated when a digital asset is selected by a user for generating an AI-based digital asset or an AI-based arrangement of one or more digital assets within a workspace. In many implementations, events can also be generated when a user provides feedback to the generative AI model to update the workspace. As such, the spatial event map provides a historical record of which digital assets have been modified by AI, what has been modified, and the prompts to which the modifications are responsive (e.g., for auditing or human validation purposes), thereby improving the explainability of the generative AI model with said historical record.

A participant of a collaboration session can select one or more digital assets (such as images, 3D models, product designs, etc.) for providing as input a trained machine learning model. The participant can include a prompt (such as a text prompt or voice prompt) for including in input to the machine learning model along with the selected digital asset. The client node can then generate an event to update the server node. The server node can update the spatial event map and propagate the other client nodes so that all users participating in the collaboration session can view the input to the machine learning model. The collaboration server can also send the prompt to an external server hosting the trained machine learning model for AI-based generation of an arrangement of one or more digital assets within the workspace based on the selected digital asset and the features provided by the user in the text or voice prompt. The one or more outputs generated by the machine learning model are received by the collaboration server (or server node). The server node can then send the output to the client nodes and send an update event to client nodes to render the output on their respective display clients.

### Space

In order to support an unlimited amount of spatial information for a given collaboration session, the technology disclosed provides a way to organize a virtual space termed the workspace, which can, for example, be characterized by a 2-dimensional plane (along X-axis and Y-axis) with essentially unlimited extent in one or both of the dimensions for example, in such a way that new content such as digital assets can be added to the space, that content can be arranged and rearranged in the space, that a user can navigate from one part of the space to another, and that a user can easily find needed things in the space when it is needed. The technology disclosed can also organize content in a 3-dimensional space (along X-axis, Y-axis, and Z-axis). A point on a 3D model is represented by its position along the three axes of the three-dimensional space.

### Events

Interactions with the workspace (or virtual workspace) can be handled as events. People, via tangible user interface devices, and systems can interact with the workspace. Events have data that can define or point to a target digital asset to be displayed on a physical display, and an action as creation, modification, movement within the workspace and deletion of a target digital asset, and metadata associated with them. Metadata can include information such as originator, date, time, location in the workspace, event type, security information, and other metadata.

The curating of the digital assets can include, generating, by the server node (or collaboration server), an update event related to a particular digital asset of the digital assets. The server node includes logic to send the update event to the client nodes. The spatial event map (SEM), received at respective client nodes, is updated to identify the update event and to allow display of the particular digital asset at an identified location in the workspace in respective display spaces of respective client nodes. The identified location of the particular digital asset can be received by the server node in an input event from a client node.

The technology disclosed includes logic to receive at the server node from at least one client node, data (such as events) identifying (or some identification of) at least two digital assets selected for comparison. The technology disclosed includes logic to send data to client nodes to curate the at least two digital assets selected for comparison in a workspace. In response to the curation by the server node, the at least two digital assets selected for comparison placed side-by-side in a same canvas.

The technology disclosed includes logic to receive at the server node from at least one client node, data (such as events) identifying the digital asset for searching sources of digital assets. The server node sends a query to the selected sources of digital assets including search keywords and/or portions of the digital asset such as an image. The search results returned by the sources of digital assets are then sent to the client nodes. The server node includes the logic to send an update event to the client nodes allowing the client nodes to display the search results in a canvas on the workspace. The search results can be displayed along with the digital asset that was selected by at least one client node to search for similar digital assets.

The technology disclosed includes logic to receive, at the server node, events including text and/or voice prompts describing the features desired in an AI-based dashboard workspace or digital asset for presentation within the workspace. The technology disclosed includes logic to receive, at the server node, events, identifying one or more digital assets or portions of one or more digital assets for providing as input to a trained machine learning model for generating the AI-based dashboard workspace or digital asset for presentation within the workspace. The technology disclosed includes logic to send to the client nodes, from the server node, events that identify the AI-based dashboard workspace or digital asset for presentation within the workspace generated by the trained machine learning model using the input including the prompt and the digital asset. The server node sends an update event to client nodes to display on their respective digital displays the AI-based dashboard workspace or digital asset for presentation within the workspace generated by a trained machine learning model.

Tracking events in a workspace enables the system to not only present the spatial events in a workspace in its current state, but to share it with multiple users on multiple displays, to share relevant external information that may pertain to the content and the understanding of how the spatial data evolves over time. Also, the spatial event map can have a reasonable size in terms of the amount of data needed, while also defining an unbounded workspace.

The following section presents a collaboration system implementing the technology disclosed in a collaborative environment.

### Environment

The technology disclosed includes a collaboration environment in which users participate in digital whiteboarding sessions or collaboration meetings from client devices (or computing devices) located across the world. A user or a participant can join and participate in the digital whiteboarding session, using display clients, such as browsers, for large format digital displays, desktop and laptop computers, or mobile computing devices. Collaboration systems can be used in a variety of environments to allow users to contribute and participate in content generation and review by accessing a virtual workspace (e.g., a canvas or a digital whiteboard). Users of collaboration systems can join collaboration sessions (or whiteboarding sessions) from remote locations around the world. Participants of a collaboration meeting can share digital assets such as documents, spreadsheets, slide decks, images, 3D models, videos, line drawings, annotations, prototype designs, software and hardware designs, user interface designs, product images and/or videos, component images and/or videos, parts images and/or videos, company logos, audio samples, textual descriptions, product brochures, etc. with other participants in a shared workspace (also referred to as a virtual workspace or a canvas). Other examples of digital assets include software applications such as third-party software applications or proprietary software applications, web pages, web resources, cloud-based applications, APIs to resources or applications running on servers.

FIG. 1 illustrates example aspects of a digital display collaboration environment. In the example, a plurality of users 101a, 101b, 101c, 101d, 101e, 101f, 101g and 101h (collectively 101) may desire to collaborate with each other to review, edit, search, curate and/or present content. For example, the plurality of users may desire to collaborate with each other in the creation, review, and editing of digital assets such as complex images, music, video, documents, 3D models and/or other media, all generally designated in FIG. 1 as 103a, 103b, 103c, and 103d (collectively 103). The participants or users in the illustrated example use a variety of computing devices configured as client devices, in order to collaborate with each other, for example a tablet 102a, a personal computer (PC) 102b, many large format displays 102c, 102d, 102e (collectively devices 102). The participants can also use one or more mobile computing devices with small format displays to collaborate. In the illustrated example the large format display 102c, which is sometimes referred to herein as a “wall”, accommodates more than one of the users, (e.g., users 101c and 101d, users 101e and 101f, and users 101g and 101h).

In one implementation, a display array can have a displayable area usable as a screen space totaling on the order of 6 feet in height and 30 feet in width, which is wide enough for multiple users to stand at different parts of the wall and manipulate it simultaneously. It is understood that large format displays with displayable area greater than or less than the example displayable area presented above can be used by participants of the collaboration system. The user devices, which are referred to as client nodes, have displays on which a screen space is allocated for displaying events in a workspace. The screen space for a given user may comprise the entire screen of the display, a subset of the screen, a window to be displayed on the screen and so on, such that each has a limited area or extent compared to the virtually unlimited extent of the workspace.

The collaboration system of FIG. 1 includes a generative AI model 110. The generative AI model can take as input at least one digital asset or a portion of a digital asset selected by a user. The generative AI model 110 can also take as input a text-based or a voice-based prompt that includes features of an AI-generated digital asset or an AI-generated layout of a plurality of digital assets as described by a user. The generative AI model 110 can provide the text-based or the voice-based prompt to a trained machine learning model for generating the AI-based digital asset(s) (and optionally, the arrangement and visual presentation of the digital asset(s) such as within an Operations Center dashboard). The trained machine learning model can be hosted on an external server. The generative AI model 110 can provide the input to the external server using an API or a connector. The output from the trained machine learning model is an AI-based digital asset or an arrangement of multiple AI-based digital assets which is received by the API and sent by the API to the collaboration server for onward distribution to client node participating in a collaboration server. In one implementation, the generative AI model logic can be implemented as part of the collaboration server (or server node). In another implementation, the generative AI model 110 can be implemented as a separate component in communication with the collaboration server. The generative AI model 110 can also include logic to process selected digital asset for adding them to the training data for training machine learning models. For example, the generative AI model can receive a digital asset or an identifier of a digital asset with one or more labels for the digital assets as recommended by a user. The generative AI model 110 can add the selected digital asset along with the label to a training data set. The generative AI model 110 can also add new labels for digital assets already saved in the training data set.

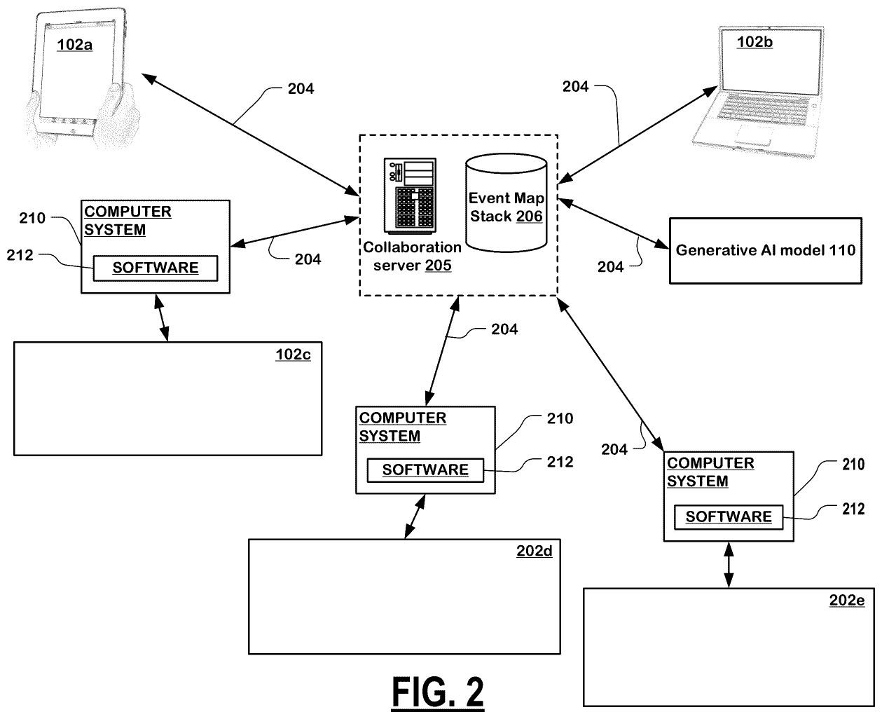

FIG. 2 shows a collaboration server 205 (also referred to as the server node) and a database 206 that can constitute a server node. Similarly, FIG. 2 shows client nodes (or client nodes) that can include computing devices such as desktop and laptop computer, hand-held devices such as tablets, mobile computers, smart phones, and large format displays that are coupled with computer system 210. Participants of the collaboration session can use a client node to participate in a collaboration session. The server node is configured with logic to receive the inputs from client nodes and process the inputs to send collaboration data (such as comments, annotations, etc.) to other client nodes participating in the collaboration session.

FIG. 2 illustrates additional example aspects of a digital display collaboration environment. As shown in FIG. 1, the large format displays 102c, 102d, 102e sometimes referred to herein as “walls” are controlled by respective client nodes, communication networks 204, which in turn are in network communication with a central collaboration server 205 configured as a server node or nodes, which has accessible thereto a database 206 storing spatial event map stacks for a plurality of workspaces. The database 206 can also be referred to as an event map stack or the spatial event map as described above. The generative AI model 110 can be implemented as part of the collaboration server 205 or it can be implemented separately and can communicate with the collaboration server 205 via the communication networks 204.

As used herein, a client device (or computing device) is an active electronic device that is attached to a network, and is capable of sending, receiving, or forwarding information over a communication channel. Examples of electronic devices which can be deployed as client devices, include all varieties of computers, workstations, laptop computers, handheld computers and smart phones. As used herein, the term “database” does not necessarily imply any unity of structure. For example, two or more separate databases, when considered together, still constitute a “database” as that term is used herein.

The application running at the collaboration server 205 can be hosted using software such as Apache or nginx, or a runtime environment such as node.js. It can be hosted for example on virtual machines running operating systems such as LINUX. The collaboration server 205 is illustrated, heuristically, in FIG. 2 as a single computer. However, the collaboration server's (205) architecture can involve systems of many computers, each running server applications, as is typical for large-scale cloud-based services. The collaboration server's (205) architecture can include a communication module, which can be configured for various types of communication channels, including more than one channel for each client in a collaboration session. For example, with near-real-time updates across the network, client software can communicate with the server communication module using a message-based channel, based for example on the WebSocket protocol. For file uploads as well as receiving initial large volume workspace data, the client software 212 (as shown in FIG. 2) can communicate with the collaboration server 205 via HTTPS. The collaboration server 205 can run a front-end program written for example in JavaScript served by Ruby-on-Rails, support authentication/authorization based for example on OAuth, and support coordination among multiple distributed clients. The collaboration server 205 can use various protocols to communicate with client nodes and generative AI model 110. Some examples of such protocols include REST-based protocols, low latency web circuit connection protocol and web integration protocol. Details of these protocols and their specific use in the presented below. The collaboration server 205 is configured with logic to record user actions in workspace data, and relay user actions to other client nodes as applicable. The collaboration server 205 can run on the node.JS platform for example, or on other server technologies designed to handle high-load socket applications.

The database 206 stores, for example, a digital representation of workspace data sets for a spatial event map of each session where the workspace data set can include or identify events related to objects displayable on a display canvas, which is a portion of a virtual workspace. A workspace data set can be implemented in the form of a spatial event stack, managed so that at least persistent spatial events (called historic events) are added to the stack (push) and removed from the stack (pop) in a first-in-last-out pattern during an undo operation. There can be workspace data sets for many different workspaces. A data set for a given workspace can be configured in a database or as a machine-readable document linked to the workspace. The workspace can have unlimited or virtually unlimited dimensions. The workspace data includes event data structures identifying digital assets displayable by a display client in the display area on a display wall and associates a time and a location in the workspace with the digital assets identified by the event data structures. Each device 102 displays only a portion of the overall workspace. A display wall has a display area for displaying objects, the display area being mapped to a corresponding area in the workspace that corresponds to a viewport in the workspace centered on, or otherwise located with, a user location in the workspace. The mapping of the display area to a corresponding viewport in the workspace is usable by the display client to identify digital assets in the workspace data within the display area to be rendered on the display, and to identify digital assets to which to link user touch inputs at positions in the display area on the display. Examples of digital assets are presented above and include rich media such as images, videos, 3D models, architectural drawings, product designs, component designs, marketing materials, etc.

The server 205 and database 206 can constitute a server node, including memory storing a log of events relating to digital assets having locations in a workspace, entries in the log including a location in the workspace of the digital asset of the event, a time of the event, a target identifier of the digital asset of the event, as well as any additional information related to digital assets, as described herein. The server 205 can include logic to establish links to a plurality of active client nodes (e.g., devices 102), to receive messages identifying events relating to modification and creation of digital assets having locations in the workspace, to add events to the log in response to said messages, and to distribute messages relating to events identified in messages received from a particular client node to other active client nodes.

The logic in the server 205 can comprise an application program interface, including a specified set of procedures and parameters, by which to send messages carrying portions of the log to client nodes, and to receive messages from client nodes carrying data identifying events relating to digital assets which have locations in the workspace. Also, the logic in the server 205 can include an application interface including a process to distribute events received from one client node to other client nodes.

The events compliant with the API can include a first class of event (history event) to be stored in the log and distributed to other client nodes, and a second class of event (ephemeral event) to be distributed to other client nodes but not stored in the log.

The server 205 can store workspace data sets for a plurality of workspaces and provide the workspace data to the display clients participating in the session. The workspace data is then used by the computer systems 210 with appropriate software 212 including display client software, to determine images to display on the display, and to assign digital assets for interaction to locations on the display surface. The server 205 can store and maintain a multitude of workspaces, for different collaboration sessions. Each workspace can be associated with an organization or a group of users and configured for access only by authorized users in the group.

In some alternatives, the server 205 can keep track of a “viewport” for each device 102, indicating the portion of the display canvas (or canvas) viewable on that device, and can provide to each device 102 data needed to render the viewport. The display canvas is a portion of the virtual workspace. Application software running on the client device responsible for rendering drawing objects, handling user inputs, and communicating with the server can be based on HTML5 or other markup-based procedures and run in a browser environment. This allows for easy support of many different client operating system environments.

The user interface data stored in database 206 includes various types of digital assets including graphical constructs, such as image bitmaps, video objects, multi-page documents, scalable vector graphics, and the like. The devices 102 are each in communication with the collaboration server 205 via a communication network 204. The communication network 204 can include all forms of networking components, such as LANs, WANs, routers, switches, Wi-Fi components, cellular components, wired and optical components, and the internet. In one scenario two or more of the users 101 are located in the same room, and their devices 102 communicate via Wi-Fi with the collaboration server 205.

In another scenario two or more of the users 101 are separated from each other by thousands of miles and their devices 102 communicate with the collaboration server 205 via the internet. The walls 102c, 102d, 102e can be multi-touch devices which not only display images, but also can sense user gestures provided by touching the display surfaces with either a stylus or a part of the body such as one or more fingers. In some embodiments, a wall (e.g., 102c) can distinguish between a touch by one or more fingers (or an entire hand, for example), and a touch by the stylus. In an embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 102c may, for example, be an array of Model No. MT553UTBL MultiTaction Cells, manufactured by MultiTouch Ltd, Helsinki, Finland, tiled both vertically and horizontally. In order to provide a variety of expressive means, the wall 102c is operated in such a way that it maintains a “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

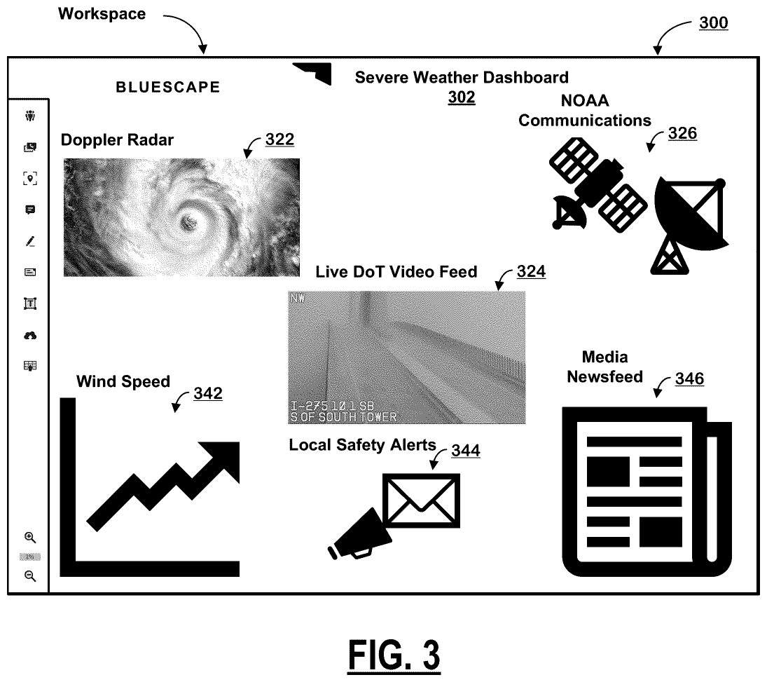

FIG. 3 presents an example of an AI-based dashboard 302 rendered in a virtual workspace 300, based on the previously described example of a hurricane dashboard. In one example implementation, the user may provide an input in the form of a selected digital asset, such as a radar image of a hurricane or a webpage presenting news updates relating to the hurricane. In another implementation, the user may provide an input in the form of a prompt, such as “hurricane updates on the gulf coast of Florida.” In some implementations, the user can provide both a selection of a digital asset and a prompt as the input. The generative AI model is then able to process the user-provided input and generate a layout of digital assets related to the input, including both newly AI-generated digital assets and preexisting digital assets extracted from a digital asset storage such as a DAM or from an Internet search query autonomously performed by the generative AI model.

For example, dashboard 302 contains a doppler feed of a tracked hurricane 322, a livestream 324 of a bridge from the Department of Transportation, a communications feed from the NOAA 326, a graph showing windspeed of the tracked hurricane 342, a local safety alert from the government in an impacted county 344, and a media newsfeed 346. The doppler feed 322 can be a static image, a GIF animation, a video, or a programmable window displaying a forecasted path from a meteorology simulation software package. The doppler feed 322 can be intermittently updated with new data as the models are updated. The livestream 324 can be accessible via a programmable window or a browser window for multi-user collaboration in the third-party application, like a web browser. In one implementation, graph 342 has been identified by the generative AI model as relevant to the input and extracted from a DAM, a weather database, or an Internet webpage. In another implementation, the generative AI model identified the raw data, selected a particular data visualization format, and autonomously generated the graph 342 to present the wind speed data. The graph 342 may also be updated by the AI at regular intervals (e.g., every hour) with new data, adjusting the visualization parameters as needed.

The dashboard 302 may also include AI-generated digital assets such as information summaries in a text format, or infographics describing important characteristics of the hurricane. The generative AI model can autonomously place and arrange digital assets within dashboard 302. In one example, digital assets are arranged by similarity. For example, forecasts, meteorology data, and video feeds 322, 324 are located near one another, and information sources such as government resources and media/news feeds 344, 346, 326 are located near one another. In another example, placement and orientation of digital assets is dependent upon size of the digital assets to ensure that digital assets can be placed within the workspace 300 at a sufficient size for viewing. In many implementations, the user may provide further feedback to the generative AI model, such as selecting video feed 324 and requesting additional, similar digital assets. In response, the generative AI model can provide additional video feeds from the DoT or footage provided by a news outlet, such as the Weather Channel. When additional digital assets are added to the dashboard 302, the generative AI model can also autonomously re-arrange the layout to accommodate the new digital assets. In addition to adding digital assets, digital assets may also be autonomously modified or deleted from dashboard 302.

The following section presents a detailed process for custom training of the AI models using the custom labeled images in the workspace. Training operations are primarily described with reference to alternate implementations of the technology disclosed in which the generative AI model is used to generate an AI-based image or scene. However, it is to be understood that the training operations described with reference to AI-based scene generation can be applicable to any other implementation disclosed herein. It will also be readily apparent to a user skilled in the art how any given feature described with reference to one respective implementation translates to any other implementation disclosed herein.

### AI-Based Scene Generation in a Collaboration Environment

Other implementations of the technology disclosed include logic to receive text-based and/or voice-based prompts from users in a collaboration session to generate AI-based images or AI-based scenes that can include at least a portion of a digital asset. One or more digital assets can be selected by users in a collaboration session for providing as input to a trained machine learning model for generating a scene that can include the selected digital assets and AI-based image features corresponding to a text and/or a voice prompt. The technology disclosed can be used in a variety of use cases such as in e-commerce applications, generation of marketing materials, etc. In this use case, a user can provide a text-based and/or a voice-based prompt describing the content in which the user wants to see a product. The technology disclosed uses the text-based and/or the voice-based prompt and the selected digital asset such as a product's image to create an AI-based scene for the user. The technology disclosed can create an immersive experience for the user by using a trained machine learning algorithm by placing the selected product's image in an AI-based image. When a user selects a particular product (e.g., a chair) for generating an AI-based image, the technology disclosed automatically selects other related products from the e-commerce application such as desks, lamps, computers, side-tables, mirrors, etc. to produce an AI-based image for the user that not only provides a view of the product in a preferred environment of the user but also introduces the user to other products that may be available to the user. For this purpose, the technology disclosed can include pre-defined associations between products for selecting related products. For example, based on user feedback and or product design, product color, etc., a particular chair can be related to a particular desk. Therefore, when that particular chair is selected by a user for generating the AI-based scene, the collaboration server (or the server node) can automatically select the particular desk for input to the trained machine learning model. In one implementation, the technology disclosed can provide options of including other products to the user to select particular products in an AI-based image. For example, when a user selects a chair, the technology disclosed can prompt the user to select from, say, five or ten designs of desks to select a particular desk that the user would like to see placed in the AI-based scene. In this way, the technology disclosed can support the e-commerce application to introduce the user to other products that are related to a particular selected product. In one implementation, the technology disclosed includes connectors or APIs to connect to third party digital asset management (DAM) systems that comprise repositories of digital assets. The technology disclosed can access digital assets from DAM systems and provide those as input to the trained machine learning model.

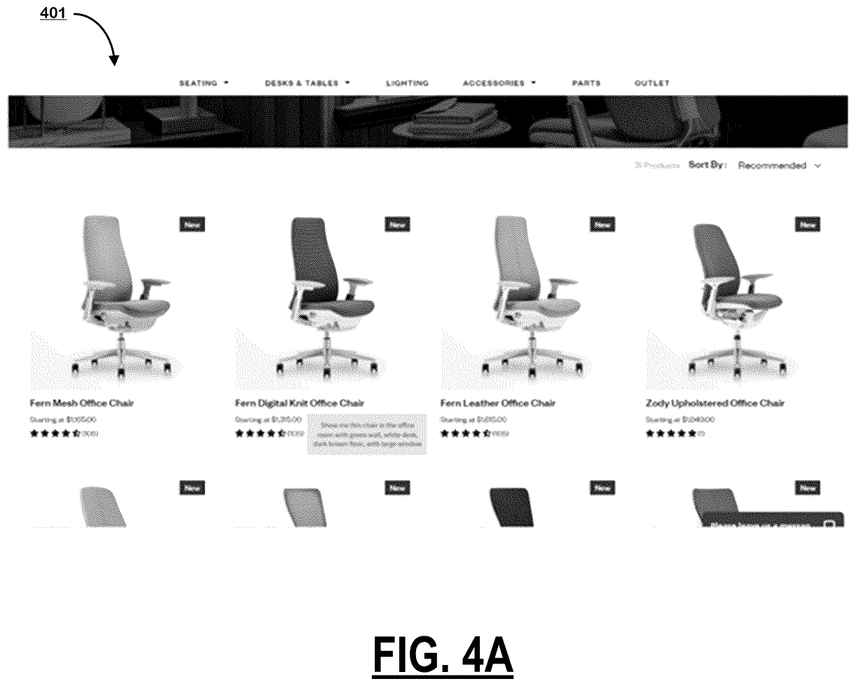

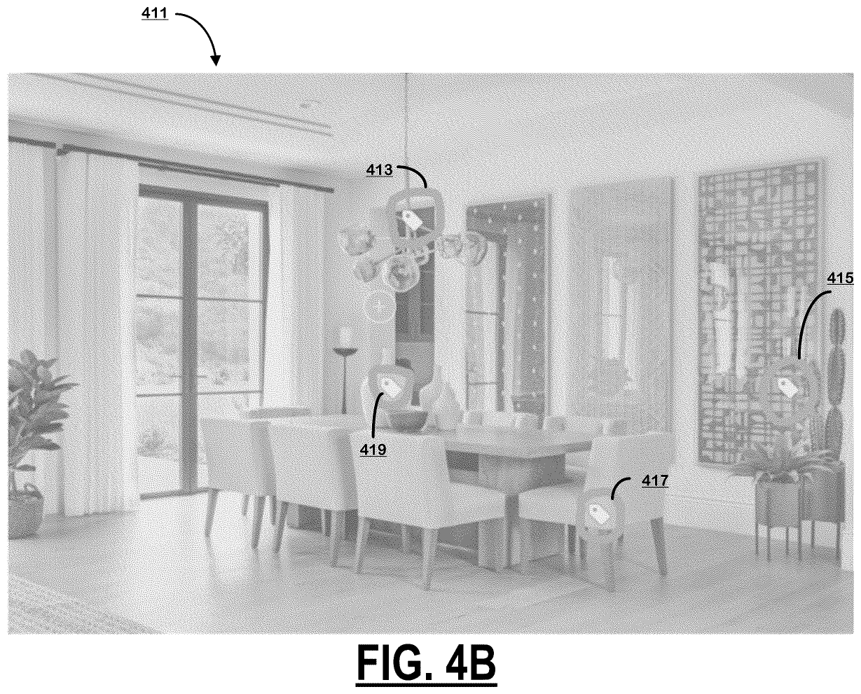

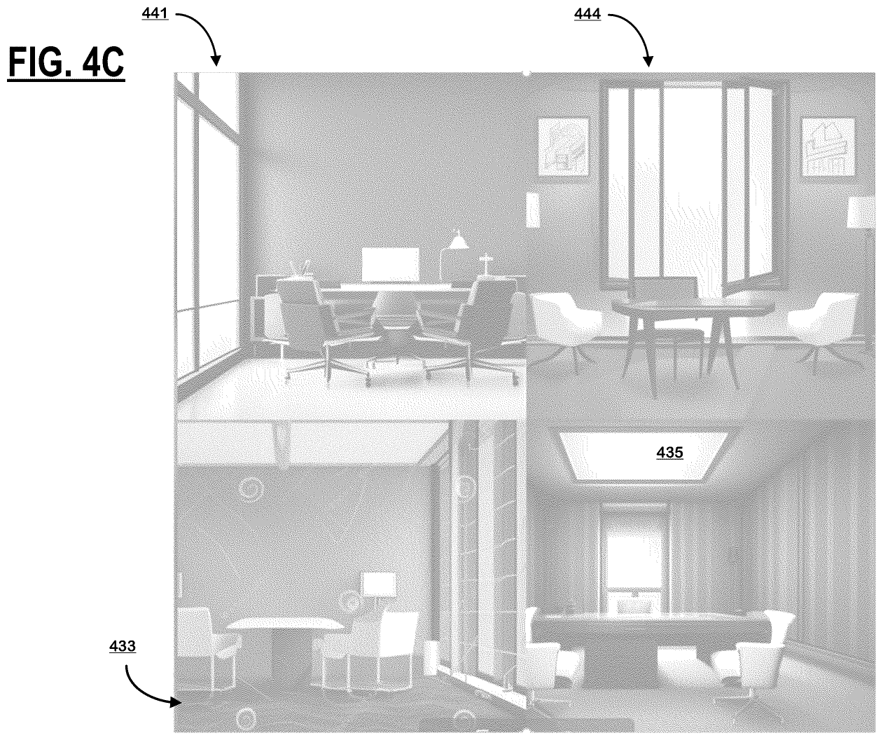

FIG. 4A shows a user interface 401 of an e-commerce application including images of products. The technology disclosed allows users to select a product from an e-commerce application for generation of an AI-based scene or an AI-based image.

FIG. 4B presents an AI-based scene or an AI-based image that is generated by the technology disclosed. The example AI-based image includes multiple products provided by the e-commerce application. The products for sale include labels or tags 413, 415, 417 and 419. A user can select a label to read further details about the product including product specifications, product price, product reviews, color options, size options, etc. A user can also select one or more products from an AI-based image or an AI-based scene to generate a new AI-based scene or AI-based image.

FIG. 4C presents another example in which a plurality of AI-based images or AI-based scenes are generated. Four images are shown in FIG. 4C including 431, 433, 435 and 437. Each of the four images presents white chairs in an office environment with an office desk. The AI-based image is generated using image and/or product selections from a user and includes features such as green walls, large windows based on text or voice prompts provided by the user. In a collaboration session, the AI-based images generated by the trained machine learning model can be saved in the workspace. The server node (or the collaboration server) can update the spatial event map so that all client nodes participating in a collaboration session can display the AI-based images.

The technology disclosed can use a variety of trained machine learning models for generating AI-based images. The technology disclosed can also train pre-trained machine learning models using proprietary labeled data related to specific organizations so that the machine learning models can generate AI-based images using proprietary data such as product images, 3D models, component images, etc. The technology disclosed can use a variety of machine learning models and frameworks to generator AI-based scenes. For example, the technology disclosed can use stable diffusion framework for generative AI. The technology disclosed can use techniques such as “dream booth” to fine tune pre-trained machine learning models using additional information including proprietary data. A pre-trained machine learning model can be trained using product images of a particular furniture manufacturer or a furniture distributor. The products manufactured by that furniture manufacturer or distributor can have proprietary names such as “Fern Chair”. The pre-trained model is trained using labeled images of the Fern chairs in a variety of colors and orientations. When the user provides a text-based or voice-based prompt that includes the name “Fern chair”, the trained machine learning model includes the images of a Fern chair from the repository of digital assets accessible to the machine learning model. The user can also specify a color of the chair in the prompt, such as, “white Fern chair”. The trained machine learning model then includes images of white Fern chair from the repository of digital assets accessible to the machine learning in AI-based scene or AI-based image. Such repository of digital assets can be managed by a digital asset management system of the furniture manufacturer or the distributor.

The technology disclosed can be used in combination with a search feature provided by the technology disclosed. The search feature allows users to search for digital assets from external sources of digital assets such as search engines, digital asset management (DAM) systems, etc. The search results are displayed on the virtual workspace. A user participating in the collaboration session can select one or more search results for providing as input to the trained machine learning model. The trained machine learning model can then generate AI-based scenes or AI-based images incorporating the digital assets provided as input to the machine learning model. The user can also add labels to the search results displayed in the virtual workspace. This can provide additional training data to train the machine learning model as searches are performed by the users of the collaboration system. The technology disclosed can use digital assets from sources of digital assets such as digital asset management (DAM) system and search engines to generate training data for the machine learning models. The participants of the collaboration system can review and label the digital assets in a collaboration session. The digital assets can be images, videos clips, 3D models, design diagrams of components, parts, machines, furniture or other type of products designed and/or manufactured by an organization. Publicly available search engines may not have access to such proprietary data. Therefore, technology disclosed allowed training of machine learning models using proprietary data. Such data is mostly not labeled. However, the collaboration system can be used to label the data and then use the labeled data for custom training of the machine learning models. In some implementations, data associated with the spatial event map of a workspace is curated as training data for subsequent training of a machine learning model. Examples of spatial event map-associated data include state data describing the state of a workspace at a particular point in time, timeseries data of events in the spatial event map as the associated digital assets of the workspace evolve over time, relational data between two or more digital assets within the workspace, and a log of entries associated with events documented within the spatial event map.

In one implementation, the technology disclosed allows users of a collaboration system to search for digital assets from sources of digital assets. The search results are returned by the external sources of digital assets to the collaboration server or the server node. The server node updates the spatial event map to identify the search results. The server node sends an update event to client nodes to display the search results in the workspace. The users can review the search results and curate the search results by selecting the search results that are relevant to their project. The users can also curate search results in separate sections or canvases on the workspace based on different criteria. The criteria can be defined based on their task or project or based on the characteristics of digital assets. For example, search results can be curated based on their relative importance to the project and/or task. The search results can be curated based on their respective sources of digital assets. The search results can also be curated based on their selection for training of the machine learning model. For example, the digital assets that are selected for training the machine learning model can be placed in a separate canvas. The participants of the collaboration session can assign labels to these digital assets and include them in the training data for the machine learning model. The machine learning model can then be trained using the labeled training data. The trained machine learning model is then provided a prompt (i.e., text-based and/or voice-based input) to generate a new AI-based scene or an AI-based image. The AI-based image can incorporate a selected digital asset provided to the trained machine learning model along with the prompt from the user. For example, the search results can include images of chairs. The participants of the collaboration session can select some search results (such as 5, 10, 15, up to 100 or more) and label those search results. These labeled search results such as images are then included in the training data set to train one or more machine learning models. The trained machine learning models can then be used to generate AI-based scenes or AI-based images. The users or participants of the collaboration search can then provide one or more search results (e.g., from the initial search results for chairs) to the trained machine learning model along with the prompt describing the desired features in an AI-based scene or an AI-based image. The trained machine learning model can generate one or more AI-based scenes or AI-based images. More than one trained machine learning models can be used to generate AI-based scenes or AI-based images.

The outputs from one or more machine learning models are then displayed on the workspace. The participants can then select one or more AI-based images from the multiple AI-based images or AI-based scenes generated by the trained machine learning models. The users can also rank the AI-based images assigning higher rank to the AI-images that provide a good representation of the desired prompt provided as input to the machine learning model. The users can select AI-based images or AI-based scenes for uploading to an e-commerce website, or for use in product or company brochures for a marketing campaign, etc. The users of the technology disclosed can be retailers or product manufacturers or e-commerce business owners, etc. In one implementation, the technology disclosed can be used by end users or shoppers. They can select a product from an e-commerce application and provide a prompt to the machine learning model to generate an AI-based image including the selected product.

In some cases, during generation of training data, portions of images that considered not relevant and/or portions of images that are not required for training the machine learning model can be removed. For example, image backgrounds or portions of images around the desired product can masked. The masked-out portions of images therefore, do not influence the training of the machine learning model.

The training data can include images or a same product in various orientations and various types of uses. For example, for a particular chair, the training data can include images of that chair in several different environments, in different orientations, in different lighting conditions, etc. The training images of the chair can include images that show persons sitting on the chair. The machine learning model is thus, trained using a variety of images of the digital asset.

In some cases, even if the training image of the digital asset is not provided for a particular usage of the product or in a particular context, the machine learning model can generate AI-based scenes or AI-based images that present the selected product in such conditions. For example, even if the training data does not include images of the chair with a person sitting on the chair, the trained machine learning model can generate AI-based scenes or AI-based images presenting the chair with a person sitting on the chair. The machine learning models can generate AI-based image presenting the product in new conditions or environments including new types of usages, new types of orientations, new types of lighting conditions, etc.

The technology disclosed can apply image processing techniques to clean images that are used for training the machine learning model. Such techniques can include separating foreground images from background images to present the objects in the foreground images in a clean image with neutral or plain background. The technology disclosed can also include combining foreground images (i.e., images of objects) with new background images that comprise features desired in the environment. For example, images of a chair can be combined with background image of various rooms with different lighting conditions, wall colors, flooring options, windows, etc. The technology disclosed can thus generate a large number of training data images for a particular object.

### Computer System

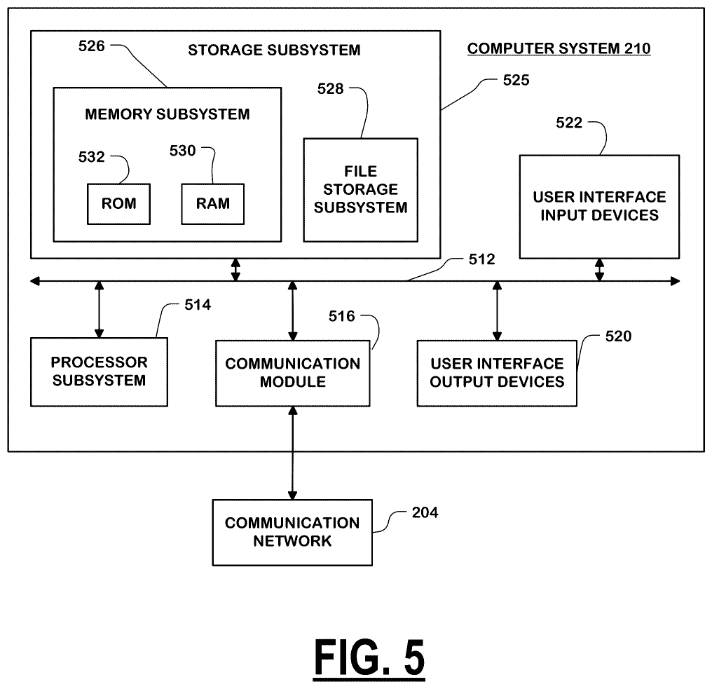

FIG. 5 is a simplified block diagram of a computer system, or client node, which can be used to implement the client functions (e.g., computer system 210) or the server-side functions (e.g., collaboration server 205) for sending data to client nodes in a collaboration system. A computer system typically includes a processor subsystem 514 which communicates with a number of peripheral devices via bus subsystem 512. These peripheral devices may include a storage subsystem 524, comprising a memory subsystem 526 and a file storage subsystem 528, user interface input devices 522, user interface output devices 520, and a communication module 516. The input and output devices allow user interaction with the computer system. Communication module 516 provides physical and communication protocol support for interfaces to outside networks, including an interface to communication network 204, and is coupled via communication network 204 to corresponding communication modules in other computer systems. Communication network 204 may comprise many interconnected computer systems and communication links. These communication links may be wireline links, optical links, wireless links, or any other mechanisms for communication of information, but typically it is an IP-based communication network, at least at its extremities. While in one embodiment, communication network 204 is the Internet, in other embodiments, communication network 204 may be any suitable computer network.

The physical hardware component of network interfaces is sometimes referred to as network interface cards (NICs), although they need not be in the form of cards: for instance, they could be in the form of integrated circuits (ICs) and connectors fitted directly onto a motherboard, or in the form of macrocells fabricated on a single integrated circuit chip with other components of the computer system.

User interface input devices 522 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto communication network 204.

User interface output devices 520 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the computer system to the user or to another machine or computer system.

Storage subsystem 524 stores the basic programming and data constructs that provide the functionality of certain embodiments of the present invention.

The storage subsystem 524 when used for implementation of server nodes, comprises a product including a non-transitory computer readable medium storing a machine-readable data structure including a spatial event map which locates events in a workspace, wherein the spatial event map includes a log of events, entries in the log having a location of a graphical target of the event in the workspace and a time. Also, the storage subsystem 524 comprises a product including executable instructions for performing the procedures described herein associated with the server node.

The storage subsystem 524 when used for implementation of client-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 524 comprises a product including executable instructions for performing the procedures described herein associated with the client node.

For example, the various modules implementing the functionality of certain embodiments of the invention may be stored in storage subsystem 524. These software modules are generally executed by processor subsystem 514.

Memory subsystem 526 typically includes a number of memories including a main random-access memory (RAM) 530 for storage of instructions and data during program execution and a read only memory (ROM) 532 in which fixed instructions are stored. File storage subsystem 528 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs and may be stored by file storage subsystem 528. The host memory 526 contains, among other things, computer instructions which, when executed by the processor subsystem 514, cause the computer system to operate or perform functions as described herein. As used herein, processes and software that are said to run in or on the “host” or the “computer,” execute on the processor subsystem 514 in response to computer instructions and data in the host memory subsystem 526 including any other local or remote storage for such instructions and data.

Bus subsystem 512 provides a mechanism for letting the various components and subsystems of a computer system communicate with each other as intended. Although bus subsystem 512 is shown schematically as a single bus, alternative embodiments of the bus subsystem may use multiple busses.

The computer system 210 itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 210 depicted in FIG. 5 is intended only as a specific example for purposes of illustrating the preferred embodiments of the present invention. Many other configurations of the computer system are possible having more or less components than the computer system depicted in FIG. 5. The same components and variations can also make up each of the other devices 102 in the collaboration environment of FIG. 1, as well as the collaboration server 205 and database 206 as shown in FIG. 2.

Certain information about the drawing regions active on the digital display 102c are stored in a database accessible to the computer system 210 of the display client. The database can take on many forms in different embodiments, including but not limited to a MongoDB database, an XML database, a relational database, or an object-oriented database.

### Deployment and Operation of Third-Party Applications in the Collaborative Environment

The digital assets included within a collaboration session can include third-party applications that can be added to a workspace by the generative AI model or by one or more participants of the collaborative session. The technology disclosed enables the participants of the collaboration session to access the features of third-party applications that are included as a digital asset in a workspace. In contrast to extensions that provide limited access to certain features of a third-party application, the technology disclosed provides a solution to this problem by providing a new type of element (e.g., a digital asset) that can be placed in the workspace. These digital assets, referred to herein as “programmable windows,” allow the third-party application to be placed as digital assets or elements in a virtual workspace, thereby supporting a common operating picture functionality of the collaboration system. A common operating picture means that a current state of the third-party application or software program is synchronized across all client nodes in a collaboration session. Additionally, when using the programmable window, the third-party application can operate in a multi-user mode because multiple users can work on the same software application from their respective client nodes. This is true even for software applications that are otherwise not multi-user enabled.

Programmable windows technology allows placement of third-party applications in a collaboration workspace to provide real time collaboration between multiple users of a collaboration system. Multiple programmable window applications can be placed in a workspace. The third-party applications provide users with various features of unstructured collaboration. The technology disclosed provides APIs that allow the third-party application to provide data to the spatial event map and also receive data from the spatial event map. The programmable window applications run inside a container placed in a virtual workspace. The technology disclosed allows two-way communication between the programmable window application and the collaboration workspace using the spatial event map and the APIs.

The programmable window applications allows users to interact with the application via a visual interface and perform operations that are usually performed on objects or digital assets placed in a collaboration workspace. For example, a user can annotate on the application in the programmable window. The APIs enable the third-party application to receive this annotation as input and store the annotation data in association with selected application content in the programmable window. For example, suppose the third-party application executing in a programmable window is a presentation application that allows users to create slides and present these slides to other users. When a user annotates on the application, the annotation data can be captured and linked to content within appropriate portion of a presentation slide. This logic to capture the annotation and link it to a slide can be implemented in a programmable window that contains the third-party application. Other types of the inputs and gestures can be captured by a programmable window application and appropriate actions can be performed. For example, a programmable window application can initiate a certain workflow when a particular gesture is performed by a user. Workflows can include deletion of content or approval of content, distribution of approved content via email, etc.

The programmable window application allows third-party developers to write logic to use data from the third-party application and perform operations based on the input. For example, data from cards in a Kanban board can be used to arrange task cards or perform other project management tasks.

Programmable window technology allows adaptation of third-party applications that are not designed for a multi-user collaboration environment to enable collaboration in a real time multi-user environment. The programmable window applications allow identification of users in the collaboration session and authorization to access resources in a collaboration session. The programmable window applications allow presence awareness to indicate which user is doing what action in real time to all users in a collaboration session. The programmable window applications allow simultaneous editing of content by multiple users in a collaboration session. The programmable window applications can be operated in a synchronous (such as in leader-follower mode, presentation mode, etc.) and asynchronous manner (in which users work independently in a collaboration session). Programmable window applications allow unstructured collaboration using annotations, use of note cards, addition and editing of comments, inclusion of snapshots, and linking content to other objects or applications in the workspace. Users can work in groups such as breakout groups and allows users to participate in voting.

The spatial event map is updated to include the data related to the third-party application including the location on the workspace and the dimensions of the window in which the third-party application executes. The third-party applications are placed in programmable window objects that can provide the synchronization and input/output features for the third-party application running in the programmable window. The spatial event map also allows creation of relationships between various programmable window applications positioned in the same workspace or across multiple workspaces. The technology disclosed allows the state of a third-party application to be replicated across client nodes of all participants. The replication of the state includes the replication of the application data across the multiple client nodes. All participants of the collaboration session, therefore, view the same state of the software application during the collaboration session.

The third-party applications can have a two-way communication with the spatial event map when these applications are executing in the programmable window. The third-party applications can receive input from the workspace and send data to the workspace. For example, when a user interacts with the third-party applications positioned in a programmable window in the workspace, the third-party application receives the data and can perform one or more operations as selected by the input. The third-party application can then can in turn also trigger actions or operations targeted towards other graphical objects, elements or digital assets in the workspace.

The technology disclosed includes APIs (application programming interfaces) or connectors to connect to third-party applications or servers that host third-party applications. These APIs and/or connectors can be used to access digital assets in a virtual workspace. The third-party application can run from within a programmable window positioned in the virtual workspace. Programmable window applications can run inside virtual workspace on the client nodes.

Programmable windows can access a variety of APIs or connectors to communicate with other elements in the workspace or external servers that host third-party applications. For example, programmable windows can access cross-window communication APIs to communicate with other applications within a client node or programmable windows that can access remote access collaboration server APIs etc. Therefore, programmable windows can communicate with other digital assets within the workspace and also communicate with collaboration server using remote APIs. There are several local APIs that can be accessed by programmable windows. For example, there is a programmable windows runtime (or executable instance) that executes inside every programmable window container. Programmable windows can communicate with the environment in which it operates and/or with the remote end such as the collaboration server and/or other servers or cloud-based storage locations, etc. Programmable windows can make API calls to the server node (such as the collaboration server) using the remote APIs to query the state of the workspace, the collaborators (or participants) list, leader-follower data (such as which participant is leading the collaboration session), permissions of participants etc.

Programmable windows can also use local APIs that are low latency, simple to use, that are provided by the programmable windows runtime environment embedded in an instance of the programmable window. The runtime environment can communicate with the virtual workspace in which it runs and get data about the current users or the state of the workspace through local communication means.

Virtual workspaces can be generated or built using history of persistent events stored in a spatial event map. In one implementation, the technology disclosed does not need to have to sift through history events to determine the current state of the workspace but it can access APIs that provide the programmable windows about the current state of the workspace. Programmable windows can query the spatial event map regarding the current state of the workspace. In one implementation, the technology disclosed implements a collaboration service API that includes a specific feature to allow the programmable window to query the spatial event map to access the current state of the workspace.

The current state is the state of the workspace elements can include data such as the position and the shape of digital assets, any data or numbers from the digital assets etc. This data can represent the state of the workspace elements.

The state information can also include e.g., who is in the workspace, who is following whom, who is in drift mode, etc. In one implementation, this data or information is volatile or ephemeral and is also referred to as transient information. This information may not be stored as history or persistent events such as events describing the visual elements that are displayed on the display screen or the digital assets that are placed on the workspace.

The technology disclosed provides the mechanisms for deploying the programmable window applications such that these applications can run or execute inside a programmable window in the virtual workspace. This logic, however, may not be enough to allow the synchronization of application across multiple users participating in the collaboration. Synchronization includes real time update or sync of app instances across plurality of client nodes. Without state synchronization, the applications would be deployed in the workspace but every user would see a different state of the same application e.g., different data displayed in the application in their respective client nodes. In this case, the application instances on various client nodes would not be connected to each other via the server node.

Synchronization (or state synchronization) is an important part of the programmable windows framework. Technology disclosed includes logic to synchronize data across instances of the application executing in various client nodes participating in the collaboration session.

Suppose there is a document and users can navigate from page to page and/or zoom in and zoom out as desired. As the technology disclosed implements synchronization of programmable windows across all client nodes, all client nodes display the same view of the application in the programmable window, e.g., the same page, the same zoom level, etc. The state of the application e.g., a document needs to be synchronized across various client nodes. The document remains synchronized across all client nodes in a collaboration and a same view of the document view is displayed all client nodes even when multiple client nodes are making edits etc. to the document.

The technology disclosed provides various programming interfaces for programmers of third-party applications to allow the third-party applications to synchronize the state of the applications across client nodes participating in the collaboration session.

The deployment and synchronization of programmable windows provides feedback of common operating picture to all participants using various client nodes in the collaboration session. The visual arrangement of the programmable windows and other digital assets are synchronized. The programmable windows act as other workspace objects (elements) or digital assets. The programmable windows can be moved to new locations in the workspace, arranged in stack or in other manner, resized, cloned (i.e., multiple copies of a programmable window can be instantiated in the workspace) etc.

The technology disclosed includes logic to create or develop an application bundle, for deploying the third-party application in the collaboration environment. Once the third-party application is deployed, the users can locate the deployment and instantiate it. When the third-party application is instantiated, it behaves as an element (as a digital asset) in the workspace.

Some other existing collaboration systems allow third-party applications to operate from within the collaboration environment, but they provide this functionality in a different manner. For example, some existing collaboration systems include so-called “extension points” in the platform. These extension points allow deployment of third-party applications in their environment. But in such systems, third-party applications are deployed with very specific extension points. For example, a menu item that offers some action. These actions do not impact the common operating picture. This means that the third-party application can be used in a particular client node but the changes in the state of the third-party application are not synchronized across all client nodes in the collaboration session. In such collaboration environments every client node in their environments runs this third-party application for themselves. Such existing collaboration systems then include additional logic to extract the state from each client node to determine the common operation picture for client nodes in the collaboration system. The common operating picture is generated from the pre-existing functionality. But the extension mechanism cannot impact the behavior of the native elements of the third-party applications.

The programmable window technology disclosed includes logic to create new kind of elements that can exist in the workspace and behave very differently from other elements. These elements support the common operating picture functionality such as synchronization of current state of those elements for third-party (i.e., third-party applications). The third-party application running on all client nodes are synchronized and display the same view or state to all users of the collaboration session.

Consider an example implementation based on the previously mentioned hurricane dashboard scenario. Many meteorology-related institutions have access to at least one software program that contains one or more proprietary weather forecasting algorithms. These programs may include features, such as the ability to select a particular forecasting algorithm or change the selected forecasting algorithm, adjust the geographical region shown (as well as map scale and directionality), look at a certain time scale range or a specific time of the forecast trend on the map, or adjust certain visual elements of the graph (e.g., adding and subtracting viewable layers that correspond to precipitation, temperature, geographic topology, labeling of states or cities, and so on). Furthermore, consider a forecasting application that typically allows presentation of a forecast, based on one specific forecasting algorithm, shown with one visualization at a time, such that the user needs to continuously “flip back and forth” between different potential forecasts and visualizations thereof.

In response to a user prompt requesting forecasting and news updates relating to the hurricane, the generative AI model may include, within the presented dashboard, a programmable window that provides access to one of the forecasting applications that is accessible to that user's organization. By incorporating the application as a programmable window in the workspace, the forecasting application is transformed into a multi-user application that all participants in the collaboration session can control, even if the forecasting application typically behaves as a single-user service. Additionally, many implementations of the technology disclosed allow participants to instantiate multiple instances of a programmable window application in the same workspace, resulting in multiple windows of the same programmable window application in the same workspace. Each programmable window application instance behaves independently, having a separate window and separate state, data, and so on. Consequently, participants interacting with the multiple instances of the application via programmable windows could simultaneously view and interact with different forecasts based on different algorithms and/or different visualizations side-by-side. Moreover, respective programmable windows can be instantiated corresponding to respective forecasting applications that each provide access to different forecasting algorithms.

In another example, consider a scenario in which a user prompts the generative AI model to output a dashboard presenting data and news updates related to an upcoming election. The user's team has been previously collaborating on a slide deck summarizing predictive data by state for the election. In addition to other relevant digital assets responsive to the user prompt, the generative AI model can also access, from memory linked to the collaboration server, a file containing the current version of the slide deck. The generative AI model can retrieve the file and instantiate a programmable window for the slide creation application (e.g., PowerPoint) with the slide deck open within the programmable window. This enables multiple participants within a session to collaboratively work on the slide deck, including full access to the functionality of the slide creation algorithm, as previously described. Moreover, the AI-generated layout includes an autonomously designed arrangement of other digital assets within the same workspace such that relevant data and information is easily accessible to all participants while they collaborate on the slide deck. Other non-limiting example use cases may include defense projects, graphic design teams, product design work, and any projects that involve collaboration between multiple teams respectively working on different various elements of the collaboration. In another implementation, the programmable window can “lock” the function accessibility for one user and prevent other users from accessing functions during that time. For example, the third-party application can be a word processing program in which the programmable window only allows one user to edit a document at a time. In other implementations, each user can access a different instance of the programmable window and enter their own respective edits to a user-specific instance, and the collaboration server will subsequently merge all edits together at a later point in time.

Users can perform annotations on the programmable windows, add comments, attach sticky notes, resize, move, etc. Because of state synchronization, all of these updates to the programmable window application instances are visible in real time to all users in the collaboration session. A programmable window application itself also goes through multiple stages, depending on the state, it acts as a keyboard focused state in which end user gestures are directed to it. The third-party application can use these gestures or input to perform operations or invoke features that are specific to this application. A programmable window application can be in a general node state in which it behaves like any other workspace element. For example, users can drag it using a pointing device such as a mouse click, etc. The mouse click action does not do any application specific action. A user can switch back and forth between these two states of the programmable window application states. Users can also clone the programmable window applications which is also a unique feature. Other operating systems usually do not allow cloning of applications. The technology disclosed allows cloning of programmable window applications. The cloned programmable window application instance can then diverge from the point when the clone is created. For example, two program editors after cloning can continue to have code written. The backend also clones the current state of the programmable window application instances. The two programmable window instances are then separately tracked and managed by the collaboration workspace. In some cases, for example, a template can be created for a software program, an UI design, a document, a presentation, etc. and then the users can clone the programmable window application to write a new program or create a new document from the template, etc.

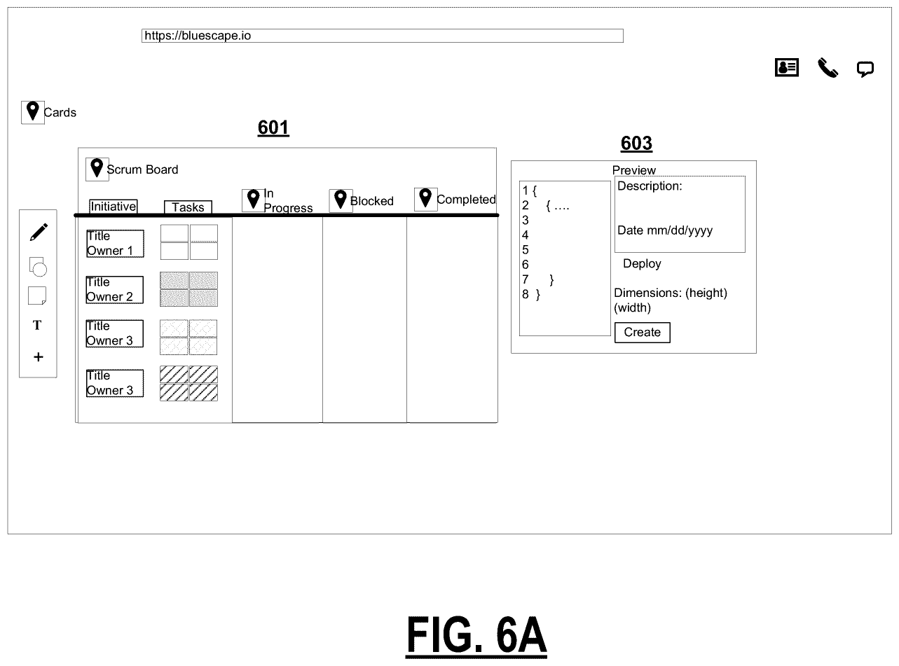

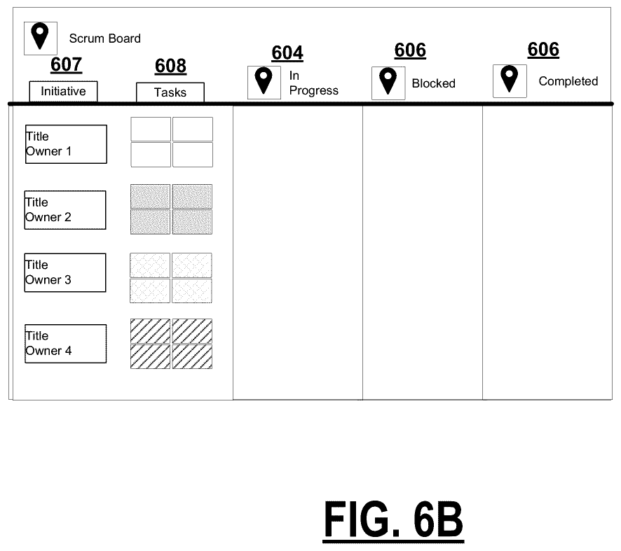

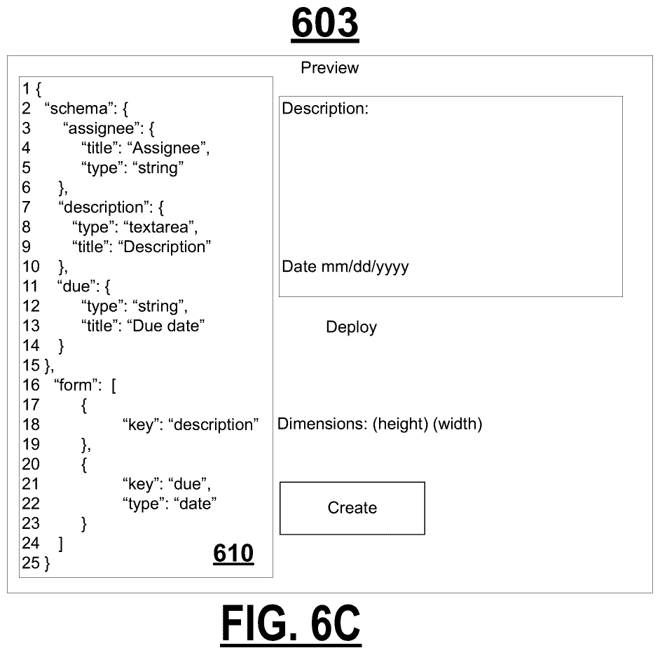

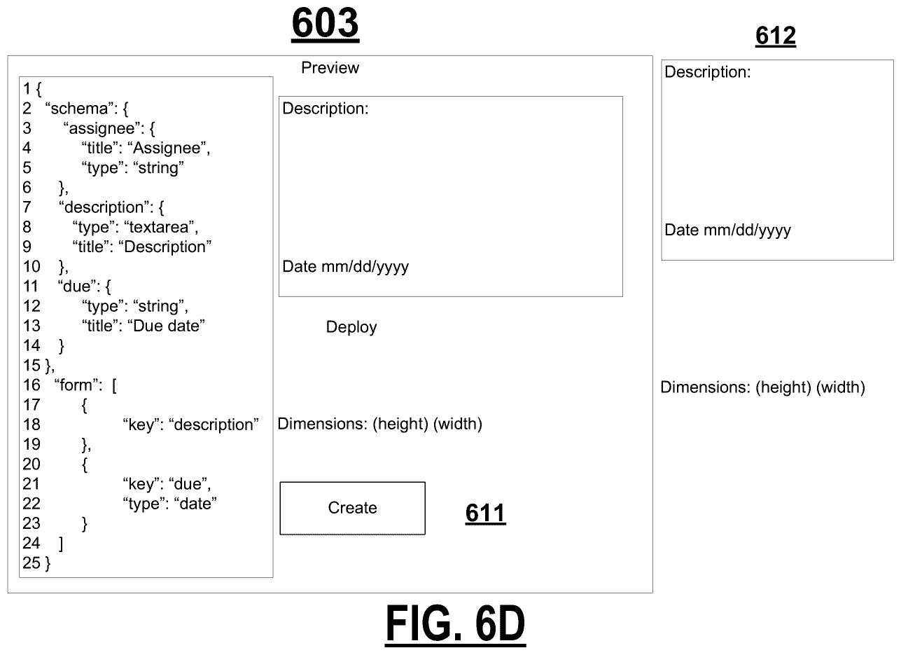

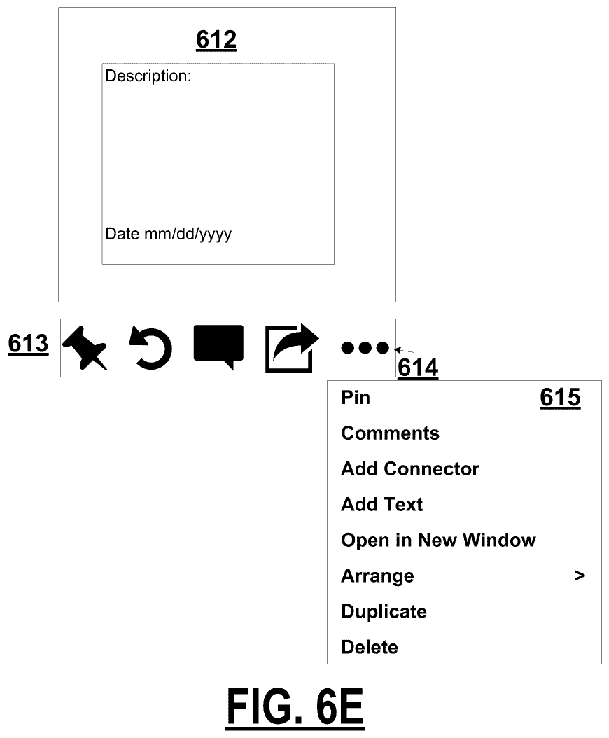

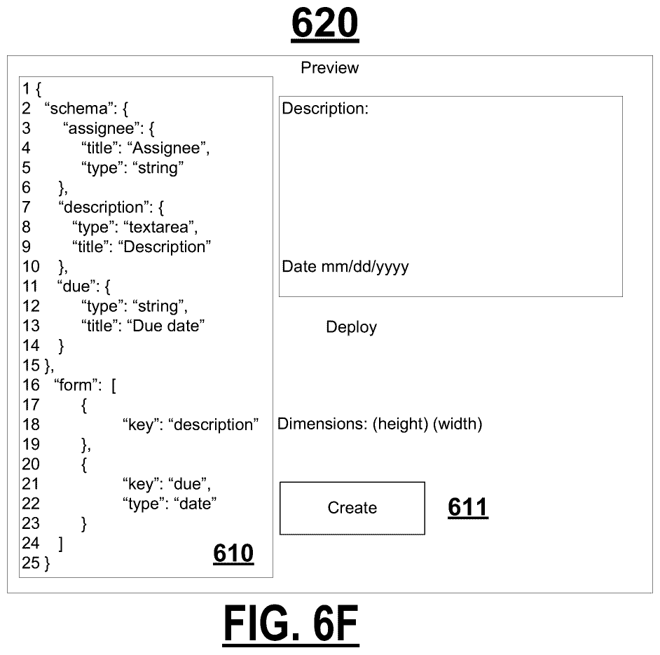

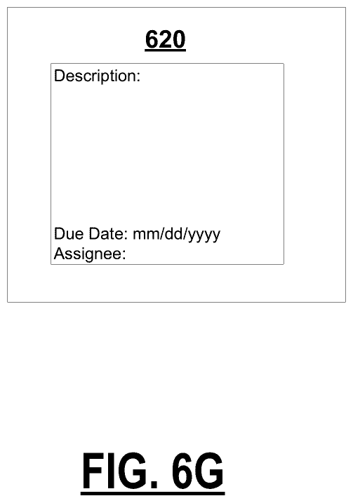

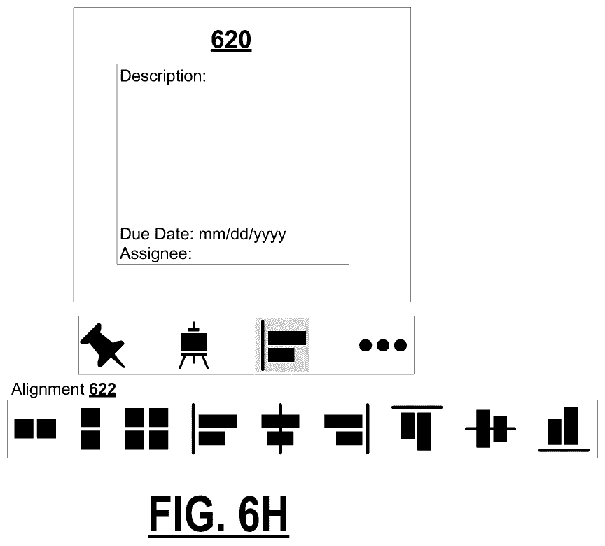

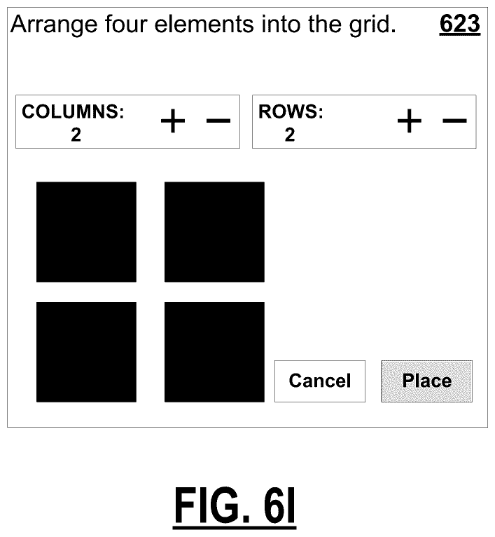

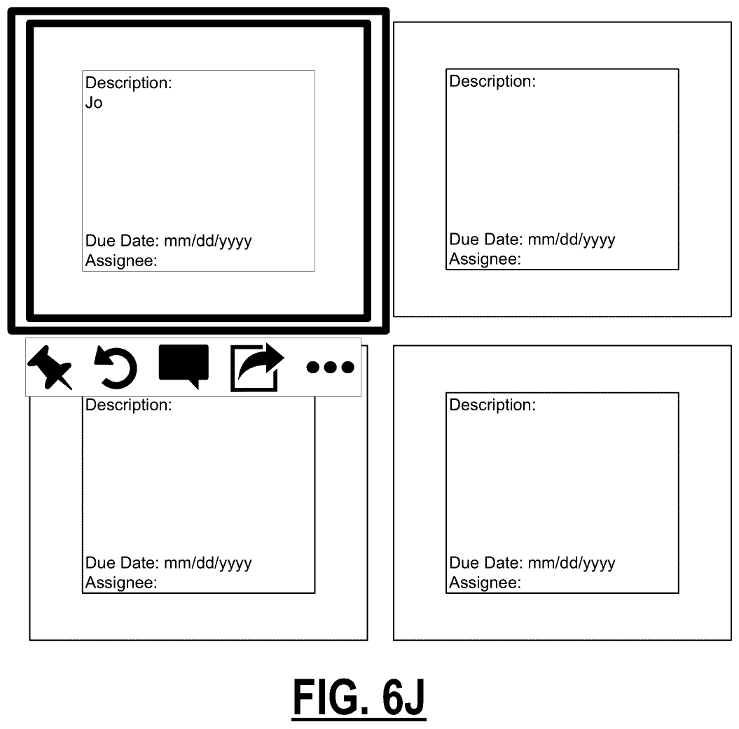

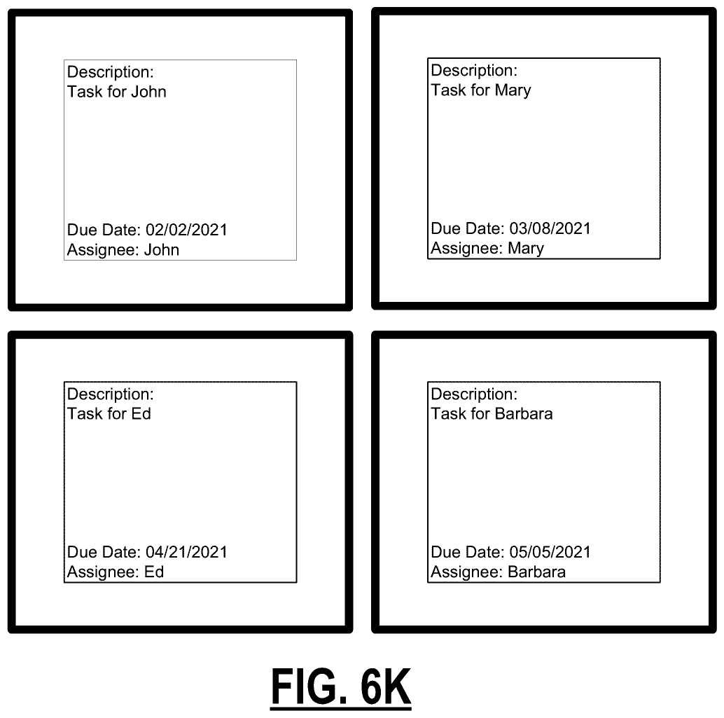

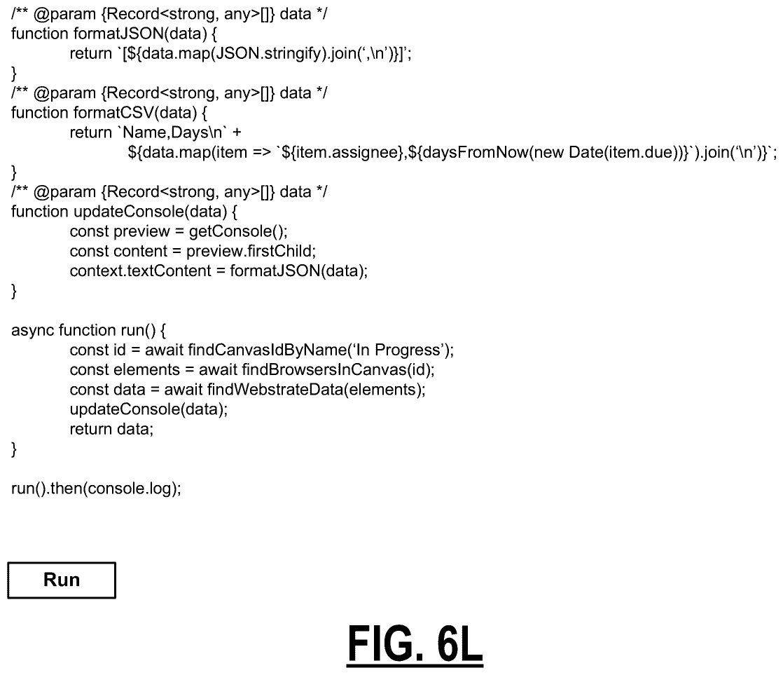

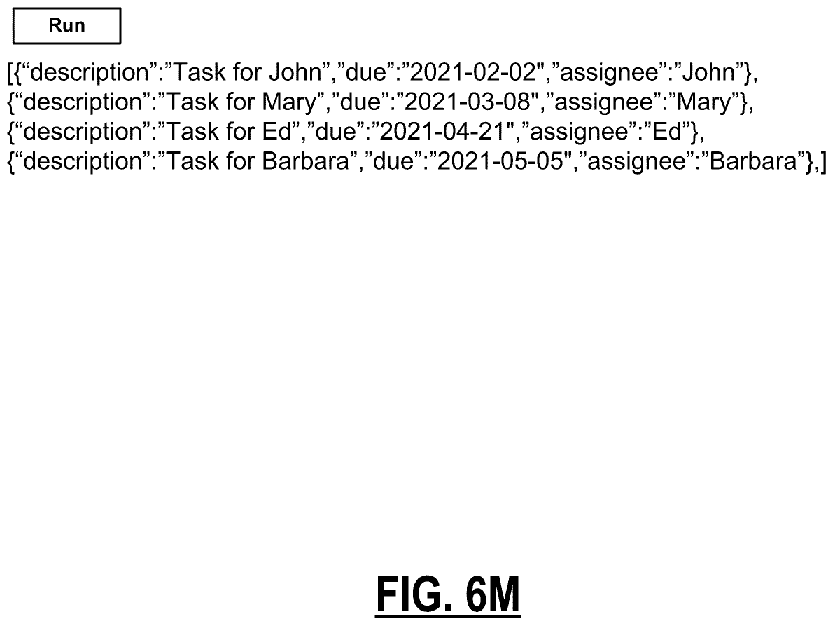

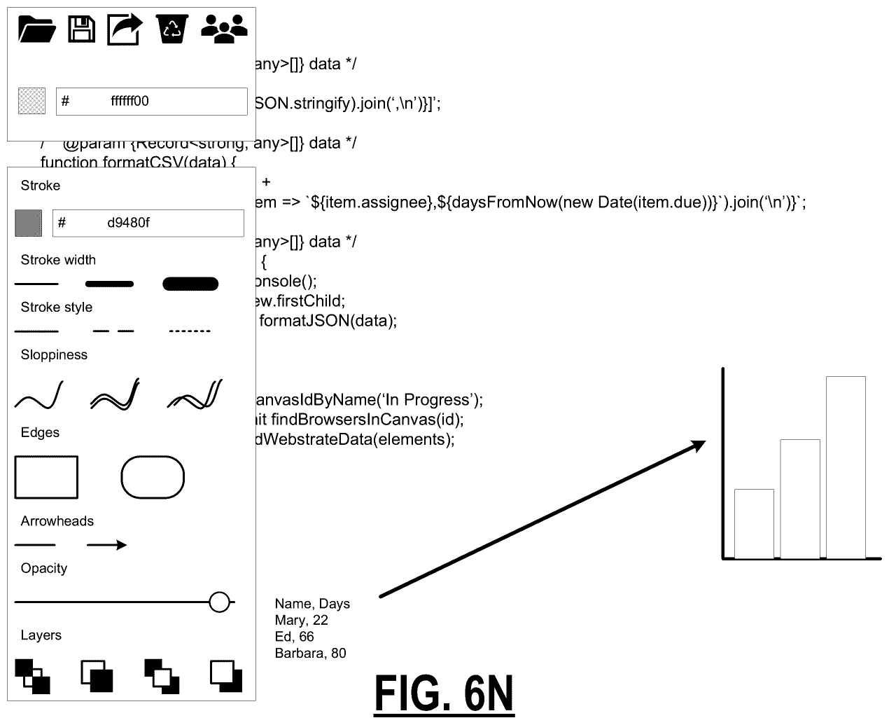

FIGS. 6A to 6N present an example illustrating a third-party application executing in a programmable window within a virtual workspace. Further details of the example are presented below with reference to FIGS. 6A to 6N. The programmable window can be instantiated by a user manually or autonomously via the generative AI model.

FIG. 6A shows a user interface 601 of a third-party application providing project management features. The user interface 601 of the third-party application presents a “scrum board” in which project tasks can be arranged in three columns labeled as “in progress” (604), “blocked” (605), and “completed” (606). A window 605 provides an example task card along with metadata description of fields in the task card. Further details of the task card are presented in reference to the following figures.

FIG. 6B presents a zoomed-in view of the “scrum board” 601 in which project tasks can be arranged in various columns. Each task can be assigned to a project member. Assignees of tasks are listed a column 607. All task cards assigned to a project member are displayed in a “tasks” column 608.

FIG. 6C presents a zoomed-in view of the task card metadata and preview window 605. The task card includes a “description” field, and a “date” field. Additionally, the width and height of the task card window can also be defined by the user. A user can select, “create” button 611 on the user interface 603 to create a task card. The descriptions of metadata fields are presented in a left-half 610 of the user interface 601.

FIG. 6D presents an example task card created by selecting the “create” button 611. An example task card is shown in a user interface 612.

FIG. 6E presents a menu list 615 that can be displayed by selecting the task card 612. When a user selects a task card 612, a task bar 613 is displayed on the user interface. The user can select a user interface element 614 on the task bar 613 to display a menu list 615. The menu list 615 presents various features such as “pin” the task card to a particular location on the virtual workspace, adding “comments”, adding “connector”, adding “text”, arranging task cards in a particular manner, “duplicating” a task card, or “deleting” a task card.

FIG. 6F presents a user interface element 620 of a task card in which a new field “assignee” has been added by a user. The user updated the metadata definition 610 to include a new field labeled “assignee” in the task card.

FIG. 6G presents a zoomed-in view of the updated task card 620. The new field “assignee” is now displayed in the task card.

FIG. 6H presents an “alignment” task bar 622 that includes user interface element to arrange tasks cards in various arrangements. A user can select a particular arrangement from the task bar to arrange the task cards accordingly.

FIG. 6I presents a grid alignment option 623 selected by a user from the “alignment” task bar in FIG. 6H. The user can select a number of columns and a number of rows to arrange task cards on the display.

FIG. 6J presents four task cards arranged in a 2×2 (two rows and two columns) matrix arrangement. This is in response to the selection of number of rows and number of columns by a user in the user interface shown in FIG. 6H.

FIG. 6K presents the four task cards with data entered in respective fields in each of the task card. The data includes task description, due date and assignee for each task.

FIG. 6L presents a portion of a program code that implements the logic to access the data from task card and present the data to project managers and/or other users of the collaboration system who want to view the status of various tasks in a project. The programmable window technology thus allows users to customize the third-party applications (e.g., by adding new metadata to task card definition) and access the functionality of third-party application to generate output based on the data provided by the users.

FIG. 6M presents output of a query that is run by a project manager and/or another user of the collaboration system to view the status of various tasks in the project. The logic described in the program code shown in FIG. 6L processes the data of task cards and outputs a data such as shown in FIG. 6M. Each row in the output presents data from one task card. The data includes description of the task, due date, assignee name or assignee identifier. It is understood that additional fields can be added to task cards as required by the project manager or other users of the collaboration system.

FIG. 6N presents a graphical output generated by the programmable window by accessing the data from the tasks.

The technology disclosed can provide visual elements for user interface design or visual programming elements (such as for generating buttons, reports, graphs, etc.) in a programmable window to allow the users to access various features of the third-party applications. The example presented in FIGS. 6A to 6N merely illustrates one implementation of the programmable window technology. The programmable window technology can be applied to a variety of third-party application to perform a diverse set of tasks.

Multi-User Infinite Canvas with Interleaved Custom Rendered Objects and Browser Rendered Objects

During a collaboration session, the participants can add a variety of content to the workspace such as images, videos, 3D models, documents, user interface designs, architectural designs, etc., as previously described. The participants of a collaboration session may provide their input by adding comments and/or annotations, or write questions, or make corrections, etc. to content presented on the workspace, such as within an AI-generated dashboard. The collaboration system includes logic that allows participants to provide such input by adding first-party elements (or first-party content) to a collaboration whiteboard (also referred to as a workspace), manually or via the generative AI model. Examples of first-party elements include annotations, comments, sticky notes, connectors, various types of geometric shapes, lines, etc. The participants may enter content to the whiteboard at any location. However, adding such content on top of a third-party application running inside a window or a frame on the workspace can cause issues and such inputs by the participants may not be correctly displayed or may even become invisible or hidden behind the third-party content displayed on the workspace. For example, the third-party applications are mostly rendered using HTML-based browser technologies while the first-party content is most efficiently rendered in the canvas. Therefore, the third-party applications are rendered on a separate plane or a separate surface than the plane or the surface on which first-party elements are rendered. In one implementation, the plane or the surface on which the first-party elements are rendered is referred to as a “canvas” and the plane of the surface on which third-party elements are rendered is referred to as a DOM (document object model) plane. In one implementation, the canvas (including first-party elements) is rendered using WebGL technology and third-party elements are rendered using HTML-based technology. It is understood that the technology disclosed can use other rendering technologies for rendering first-party and third-party elements. The first-party elements can also be referred to as custom rendered objects or custom rendered elements and the third-party elements can be referred to as browser rendered objects or browser rendered elements.

The canvas (also referred to as infinite canvas as it can expand infinitely in any direction) can be rendered as a transparent surface. Therefore, the third-party elements (or third-party content) such as third-party applications can be displayed below the canvas surface providing an illusion to the users that the third-party content is displayed on the canvas surface. This can work as long as the users do not need to interact with the third-party application. However, in many cases, the users need to interact with the content in the third-party applications, as previously described above with reference to programmable windows. For example, the third-party application can be a PDF document reader. A PDF document can be displayed in the third-party PDF reader positioned below the canvas surface. This mode of operation and/or mode of rendering of the third-party application is referred to as a passive mode or passive state of the third-party element. In passive mode, the user is not able to interact with the content displayed by the third-party application. Suppose the PDF document displayed by the PDF reader positioned below the canvas comprises multiple pages and a user selects the PDF reader to scroll through the PDF document. Upon selection, the PDF reader application changes from passive mode or passive state to active mode or active state. In the active state, a user can interact with the PDF reader application. However, as the third-party application (i.e., the PDF reader) is placed below the canvas, it is rendered below the transparent canvas plane, therefore, the user is not able to interact with it. To overcome this limitation, the existing whiteboarding systems render the third-party application above the canvas plane when the third-party application is in active mode or active state so that the user can interact with the third-party element. This allows the user to interact with the third-party application such as scroll through the pages of the PDF document displayed in a PDF reader application. However, as the first-party elements are rendered in the canvas (rendered below the active third-party element), first-party content may not be added to content displayed by third-party applications. Therefore, existing canvas-based whiteboarding technologies have a limitation due to which first-party content may not be added to the content of the third-party applications. When in active mode or active state, any first-party content entered by the user on the window of the third-party application will be occluded as it will be rendered on the canvas which is below the third-party application. This is because when the third-party application is in active mode, it is rendered above the canvas plane or the canvas surface.

Many implementations of the technology disclosed allows interleaving of the third-party elements (or third-party applications) that are rendered in HTML with first-party elements using so called “cutouts” in the canvas. Some implementations involve creating a cutout in the canvas for each third-party element that is rendered below the canvas surface. The cutout allows a third-party application to receive input from the user while being rendered below the canvas surface. Therefore, the technology disclosed does not require the third-party applications to be rendered above the canvas surface when in active mode. In one implementation, the technology disclosed allows multiple cutouts in the canvas surface for allowing multiple third-party applications positioned below the canvas surface. Additional implementations of the technology disclosed include logic to maintain a stacking order amongst the third-party applications positioned below the canvas surface and first-party content positioned in/on the canvas. The technology disclosed therefore, allows the users to add first-party content on the third-party content displayed by the third-party applications. In many implementations, the technology disclosed also includes logic to maintain a stacking order for all first-party content rendered on the canvas surface. Therefore, said implementations allow the whiteboard-based collaboration systems to easily incorporate any third-party application in the workspace without requiring any changes to the third-party application or without requiring the need for developing a new version of the third-party application using the first-party development framework. Therefore, the technology disclosed not only solves an important interaction problem with third-party applications in a whiteboarding session, but it also opens the inclusion of a large number of third-party applications into whiteboarding sessions without requiring any re-engineering or re-development of the third-party applications.

The collaboration system of FIG. 1 can further include a cutout engine (not shown in FIG. 1) in some implementations. The operations of the cutout engine described below can be performed independently from the generative AI model, or in dependence upon the generative AI model when the digital asset(s)/element(s) associated with the operations are being created or modified by the generative AI model. For example, if an existing third-party application digital asset within a workspace is modified or re-positioned within the virtual workspace, the generative AI can also autonomously trigger the cutout engine to update a cutout associated with the asset within the workspace.

The cutout engine includes logic to calculate dimensions (length, width, radius, etc.) and positions of cutouts in the canvas. The cutout engine also includes logic to determine the geometric shape of cutouts. The geometric shape of a cutout can match the geometric shape of a corresponding third-party element. In one implementation the canvas is rendered using WebGL technology and is also referred to as a WebGL plane. It is understood that the canvas can be implemented using other technologies. For example, the canvas functionality can be implemented using Canvas 2D (2D immediate mode drawing API), WebGPU (3D, that is successor to WebGL), and/or ImageBitmap (including any technology capable of producing 2D bitmap images may be used). Web browser supported plugins such as, Java, Flash, Silverlight, DirectX, and/or Unity may be used to implement the canvas. Newer web browsers may not support some of the above-listed plugins. Embedded, or other non-standard web browsers with custom modifications may expose any rendering technologies available in the given environment. The canvas can be a transparent plane or transparent surface that stretches infinitely along horizontal and vertical axes. The cutout engine can generate a cutout in the canvas such that the cutout corresponds to a third-party element rendered by a browser in the DOM plane. The third-party elements or third-party digital assets can be rendered using HTML-based technologies or any other third-party rendering technologies or frameworks, and may be AI-assisted in some implementations. In many web browsers, rendering of third-party elements is generally limited to the technologies available in the browser itself, such as HTML, SVG, MathML, as well as Canvas2D, WebGL, and/or WebGPU. That is, third-party elements may also be rendered using separate instantiations of various browser canvas technologies, the canvas technology used could be different or the same as for the main canvas. Various third-party libraries and frameworks can be used in the rendering process, though all of them would have to rely on the technologies exposed by the browsers for the final rendering. Web browser plugins can also be used for rendering third-party elements. Examples of plugins include Java, Flash, Silverlight, DirectX, and/or Unity. For every third-party element, a cutout is generated in the canvas having the same shape and dimensions as the third-party element and the cutout is placed at a position that exactly matches the position of the third-party element in world coordinates. Therefore, the cutout engine can be imagined as creating a hole in the canvas through which users can then interact with third-party elements (or third-party digital assets) that are rendered on the DOM plane positioned below the canvas plane. The third-party elements can be rendered on the DOM plane in both passive and active states. Therefore, the third-party elements are not needed to be rendered on top of the canvas when in active state. Therefore, the technology disclosed allows users to add first-party elements such as annotations, comments, sticky notes, etc. on active third-party elements. The technology disclosed can therefore remove a key limitation of the existing whiteboarding technologies and allow whiteboarding systems to incorporate any third-party element in a whiteboarding session with complete interaction and collaboration features as provided by first-party elements. The users can interact with third-party elements, review content using third-party elements and use various features provided by the third-party elements. For example, a user can use all features provided by a PDF (portable document format) reader application running in the browser as a DOM element through a cutout in the canvas. The user can also use first-party elements such as annotations and sticky notes to include their comments and notes on the content in the PDF reader. The technology disclosed can spatially link the annotations, lines, connectors, shapes, sticky notes and other first-party elements to content in third-party elements or third-party applications. The first-party elements can be linked to a particular location on a page of a PDF such as top left, top right, bottom left, etc. The exact location of the first-party element on the content of a third-party element is defined by (x, y) values along horizontal and vertical axes of coordinates in world space.

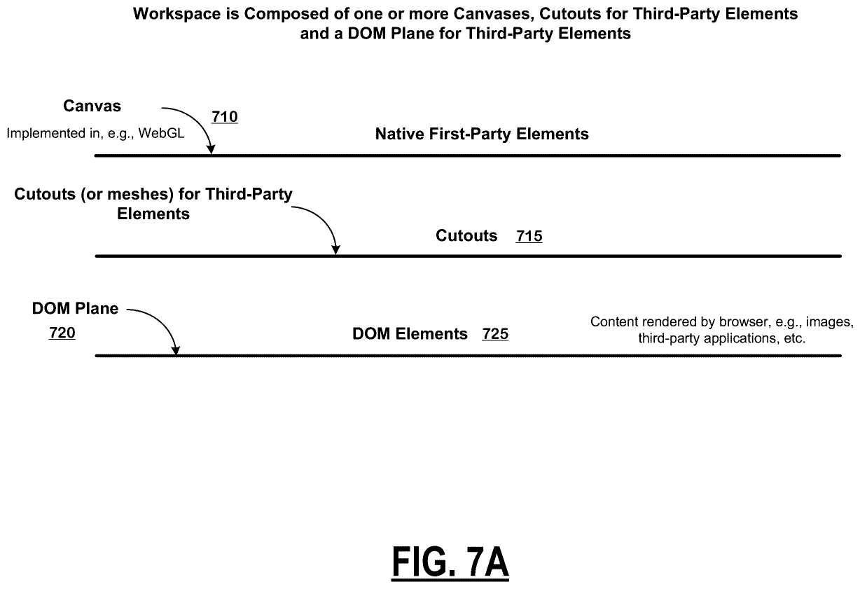

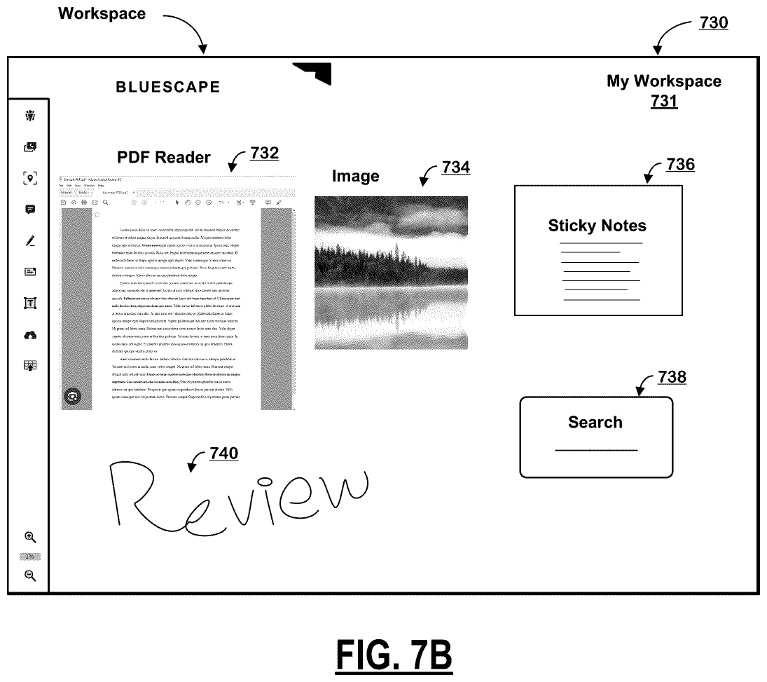

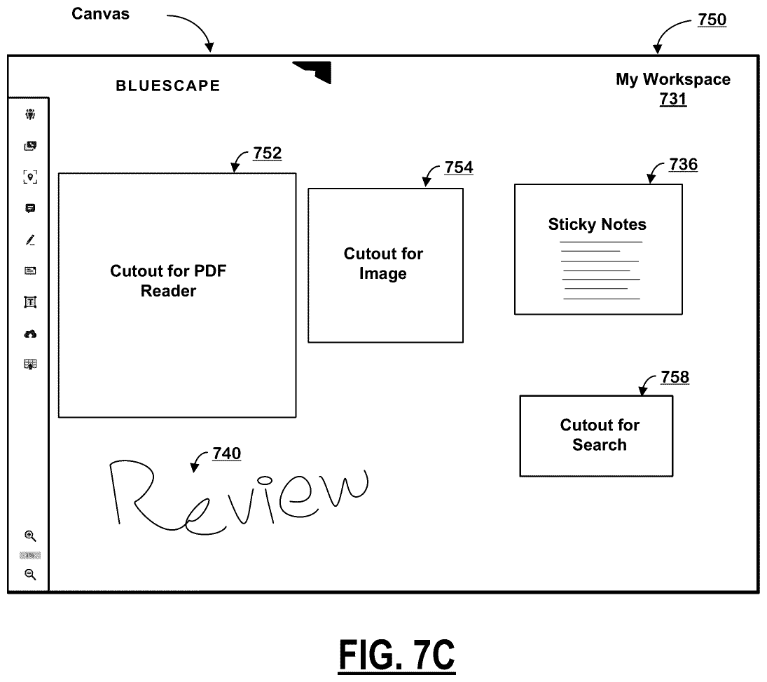

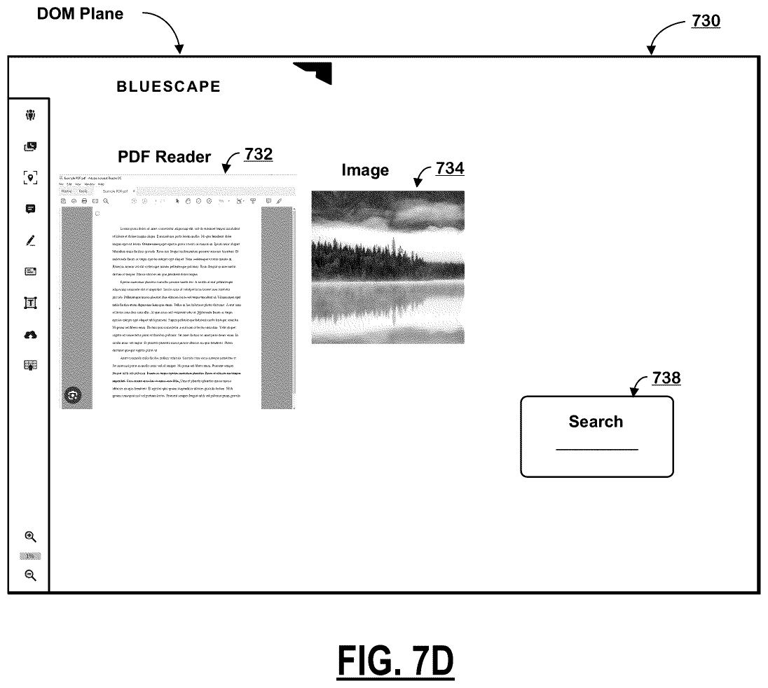

The cutout engine includes logic to determine how overlapping first-party elements and cutouts corresponding to third-party elements are rendered. Rendering a first-party element on the canvas involves creating or updating one or more meshes, or visual objects with defined geometry and surface appearance. Rendering a third-party element involves creating or updating a cutout mesh. The cutout engine includes logic to determine the result of composing two or more meshes. The cutouts corresponding to two third-party elements can overlap in the canvas if the two third-party elements overlap in DOM plane. Cutout meshes can also overlap meshes used to render first-party elements in the canvas. In general, when a mesh is placed over another mesh, the color of the overlapping area is determined by the so-called blending mode. In the most commonly used blending mode, when a transparent surface is placed over a solid surface, the solid surface is visible underneath the transparent surface. However, in the “no-blending” blending mode used by the cutout engine, the mesh at the top determines the resulting color of the area underneath it. In the case of cutout meshes, the color is transparent, and if a cutout mesh is on top of other meshes, the entire area of overlap takes on the transparent color and makes the corresponding third-party element visible to the users. The cutout mesh or cutout at the top is transparent like all cutout meshes or cutouts but as it is on the top, the cutout engine slices through all the first-party elements on the canvas surface and allows display of the third-party element (or third-party digital asset) corresponding to the cutout on the top. In addition, the cutout engine maintains the stacking order of third-party elements in the DOM plane, such that if one cutout mesh is placed above another cutout mesh in the canvas, their corresponding DOM elements are also in the same stacking order. Therefore, the technology disclosed allows display of first- and third-party elements placed at any location in the canvas even when first- and third-party elements overlap each other arbitrarily. Further details of the technology disclosed are presented with reference to FIGS. 7A to 7D.

Both first-party elements and third-party elements are rendered using one or more meshes. The term “mesh” is used in the context of rendering of 3-dimensional (3D) graphics or 3D objects. Further details of mesh are available on <<en.wikipedia.org/wiki/Polygon_mesh>>. Meshes (representing several different graphical objects) can be stacked on top of each other. Rendering of meshes (of graphical objects) that are stacked on top of each other is determined by blending mode properties of respective meshes as described on <<en.wikipedia.org/wiki/Blend_modes>>.

The disclosed cutout engine uses one or more meshes to render first-party elements. In some cases when the entire first-party element or a portion of the first-party element is outside the viewport of the display associated with a client node, the technology disclosed may not render the first-party element or the portion of the first-party element that is outside of the viewport.

The technology disclosed uses a combination of a “cutout” mesh and a corresponding third-party element (or DOM element) for rendering the third-party elements. A third-party element (or DOM element) is rendered using at least one third-party element on the DOM plane and a corresponding cutout mesh on a canvas plane. A canvas plane may be positioned above the DOM plane. The cutout or the cutout mesh is of the same size and dimensions as the corresponding third-party element. The cutout mesh can be rendered using more than one “cutout” meshes, as long as, in combination, the meshes have the same geometry as the visible area of the third-party element rendered in the DOM plane.

The cutout meshes can be rendered as transparent elements (or transparent objects) and their blending mode can be set as “no blending”. There are several blending modes that can be assigned to meshes. In general, non-cutout meshes (such as first-party elements and third-party elements) are assigned “normal” blending mode. Other blending modes can also be assigned to non-cutout meshes. In the “normal” blending mode, the color of the area of overlap of two meshes is determined by the mesh on top, unless the mesh on top is partially or completely transparent, in which case the resulting color can be a combination of the two colors. The combination of the two colors is determined via a process called alpha-blending or alpha-compositing as described on <<en.wikipedia.org/wiki/Alpha_compositing>>. The “normal” blending mode generally corresponds to the intuitive behavior of graphical objects in three-dimensional space.

The cutout elements or cutout meshes can be rendered using “no blending” blending mode. When rendered in “no blending” mode the color of the overlap of two meshes is determined by the mesh on top, without alpha-blending. If the mesh is transparent (such as a cutout meshes), the entire area of overlap becomes transparent, which has the effect of visually cutting through all the first-party elements and revealing what's underneath the canvas, which is the third-party or DOM elements with the matching geometry. This slicing effect only applies to the meshes that are below a cutout mesh in the stacking order, so a first-party element can be placed on top of a third-party element, and partially obstruct the view of the third-party element, because its mesh or meshes are placed above the corresponding cutout mesh. But if the same first-party element is placed below the given third-party element, the cutout mesh will cut through the first-party element's mesh(es), thus revealing the corresponding third-party element.

All elements (including first-party elements and third-party elements) in a workspace can have a stacking order that corresponds to the user's perception of how these elements are arranged in the workspace. All meshes in the canvas can also have a stacking order (which can be determined by the canvas API). The third-party elements can have a stacking order in the DOM plane (which can be determined by the DOM APIs). The technology disclosed includes logic such that the DOM and canvas stacking orders are consistent with each other. For example, if a cutout mesh A is above a cutout mesh B in the canvas, the DOM element corresponding to cutout mesh A is also rendered above the DOM element corresponding to cutout mesh B in the stacking order. As mentioned above, all elements, including first-party and third-party elements, have corresponding meshes in the canvas (unless removed when an element is positioned outside the viewport, as a memory optimization). The stacking order and overall arrangement of elements in the workspace may be determined at least in part using the generative AI model as layouts are autonomously generated including third-party elements.

The cutout engine includes logic to allow two or more third-party elements to be rendered consistently using the workspace stacking order and to ensure that the DOM stacking order is consistent with the workspace stacking order. The cutout meshes create a hole in the canvas and the DOM stacking order is visible through it. The cutout engine includes logic to allow rendering of first-party elements. The cutout engine also includes logic to ensure that rendering of first-party elements is consistent with the workspace stacking order. This is because the canvas stacking order is consistent with the workspace stacking order.

The cutout engine includes logic to ensure that rendering of the first-party elements is consistent with the rendering of third-party elements. The first-party elements are rendered consistently with the workspace rendering order because when the first-party element is on top, the mesh of the first-party element obstructs the cutout mesh and correspondingly obstructs the third-party element (or DOM element) beneath the cutout mesh that corresponds with the cutout mesh. In case a third-party element (or DOM element) is on top in the stacking order, the corresponding cutout mesh slices through the mesh(es) of the first-party element(s) to reveal the third-party element. This makes sure that in the case when the third-party element is on top in the stacking order, corresponding cutout mesh of the third-party element slices through the meshes of the first-party element to reveal the third-party element and the third-party element appears to obstruct the overlap area of the first-party element that is below the third-party element in the stacking order.

FIGS. 7A to 7D present an example of rendering first-party elements (also referred to as custom objects or first-party content) and third-party elements (also referred to as browser objects or third-party content) on a workspace.

FIG. 7A presents an example illustrating different layers that can be combined to form a workspace for a whiteboarding session. The top layer is a canvas 710 that can be extended infinitely along x and y axes of a two-dimensional space. The canvas can be implemented using e.g., the WebGL technology or any other rendering technology. The canvas can be transparent and first-party elements (also referred to as first-party digital assets or native elements) can be rendered on the canvas. Examples of first-party elements include annotations, sticky notes, lines, connectors, shapes (such as two-dimensional or three-dimensional shapes), etc. A plurality of cutouts (or cutout meshes) 715 can be placed on the canvas. The cutouts 715 can be imagined as holes in the canvas 710 (also referred to as the canvas layer or canvas surface). In FIG. 7A, the cutouts 715 are shown below the canvas 710 for illustration purpose to show them separate from the canvas layer. For each third-party element (or third-party digital asset or third-party app or programmable window app, etc.) a cutout (or a cutout mesh) with the same geometrical shape and dimensions is positioned on the canvas. The cutouts are also referred to as cutout meshes. Each first-party element is rendered on the canvas using one or more regular (non-cutout) meshes. Multiple cutout meshes or cutouts can be placed on the canvas corresponding to multiple third-party elements. A cutout mesh or a cutout corresponding to one third-party element can overlap with one or more meshes corresponding to multiple other first-party and third-party elements. When two or more meshes overlap with each other, and the mesh on top is a cutout mesh, the third-party element corresponding to the cutout on the top is visible and not obstructed by other first- or third-party elements. The cutouts or the cutout meshes can be transparent. The third-party elements (or DOM elements) 725 are rendered by a browser using HTML-based technology on a DOM plane 720. Examples of third-party content include images, videos, documents, 3D models, web applications, etc. The third-party elements can be rendered in either a passive mode (or passive state) or in an active mode (or active state). When rendered in the passive mode, the user may not interact with the applications running in third-party elements. Therefore, existing whiteboarding systems display the third-party elements below the canvas when the third-party elements are rendered in passive mode. The canvas can be transparent and therefore, the third-party elements when rendered on a DOM plane that is positioned below the canvas are visible to the user of the collaboration system. However, the existing whiteboarding systems cannot render the third-party elements below the canvas when the third-party elements are in active mode (or in active state). This is because the users need to interact with the third-party elements in active mode. Therefore, existing whiteboarding systems render third-party elements above the canvas when the third-party elements are in active mode to allow users to interact with third-party elements. However, this approach does not allow interleaving of first-party elements, i.e., annotations, lines, shapes, sticky notes, etc. with third-party elements. As the active third-party elements are rendered above the canvas, the user may not add annotations, sticky notes, etc. on the active third-party elements. The technology disclosed addresses this limitation of existing whiteboarding systems by providing cutouts or cutout meshes corresponding to DOM elements. A cutout or a cutout mesh allows a user to interact with a third-party element rendered on the DOM plane. This is because the cutout or the cutout mesh slices through the canvas and all first-party elements placed above the target third-party element to expose the active third-party element to users through the canvas. The users can therefore interact with the active third-party element through the cutout. The users can add annotations, lines, sticky notes (or other types of first-party elements) to the active third-party elements while the active third-party element is rendered on the DOM plane positioned below the canvas.

FIG. 7B presents an example workspace 731 labeled as “My Workspace” displayed in a user interface 730. The workspace 731 includes three third-party elements (or third-party digital assets or third-party applications) and two first-party elements (or native elements or native digital assets or native applications). The third-party elements displayed on the workspace 731 include a PDF reader 732, an image 734 and a search widget 738. The first-party elements displayed on the workspace 731 include a sticky notes application 736 and an annotation 740. As described above with reference to FIG. 7A, the third-party digital assets 732, 734 and 738 are rendered on the DOM plane which is positioned below the canvas plane or canvas surface. The first-party elements 736 and 740 are rendered on the canvas. The canvas is transparent, therefore, the third-party elements 732, 734 and 736 are visible to the users through the canvas.

FIG. 7C presents another view 750 of the example workspace 731. In the view 750, the canvas plane or canvas surface of the workspace 731 is shown. In one implementation, the canvas surface or canvas plane can be implemented using the WebGL technology. As described above, other technologies can be used to render the canvas plane or the canvas surface. The canvas plane can be transparent. Two first-party elements including a sticky notes application 736 and an annotation 740 are rendered on the canvas plane. In addition, the canvas plane includes cutouts or cutout meshes for third-party elements rendered on the DOM plane that is positioned below the canvas plane. For example, the canvas shown in the view 750 includes three cutouts or cutout meshes 752, 754 and 758. The geometric shapes and dimensions of these cutouts match the geometric shapes and dimensions of respective third-party elements rendered on the DOM plane. For example, the length and width of the cutout 752 matches the length and width of the window of frame encompassing the third-party element 732. Similarly, the lengths, widths and geometric shapes of the cutouts 754 and 758 match the lengths, widths and geometric shapes of the windows (or frames) encompassing the third-party elements 734 and 738, respectively. The cutouts or cutout meshes slice through the canvas to expose or reveal the third-party elements rendered on the DOM plane. As described above, the third-party elements can be rendered using other technologies as well. The cutouts or cutout meshes on the canvas plane allow the technology disclosed to render the third-party elements below the canvas plane even when the third-party elements are rendered in active mode or active state. This is because the cutouts or cutout meshes can be imagined as holes in the canvas plane and allow the users to interact with the third-party elements through the cutouts. For example, a user can interact with the PDF reader third-party element 732 that is rendered on the DOM plane below the canvas through the cutout 752 in the canvas plane. Therefore, the users can annotate and/or add comments, attach sticky notes, draw shapes, lines or connectors on the third-party elements even when the third-party elements are rendered below the canvas surface. The users can also access the features provided by third-party application while these applications are rendered in DOM plane below the canvas plane. For example, a user can interact with the PDF reader 732 through the cutout 752 to scroll the PDF document, use review tools provided by the PDF reader 732 to highlight or underline selected text, etc.

FIG. 7D presents a view 770 illustrating content rendered on the DOM plane. The DOM plane is positioned below the canvas plane or the canvas surface. The third-party elements are rendered on the DOM plane. The example in FIG. 7D shows three third-party elements rendered on the DOM plane including a PDF reader 732, an image 734 and a search widget 738. The technology disclosed allows users to interact with third-party elements through respective cutouts or cutout meshes on the canvas plane. The cutouts are placed at the same location as the position of the third-party elements and their geometric shapes and dimensions match the dimensions of the respective third-party elements. The inputs from the users are passed through the cutouts to the third-party elements. For example, a user can scroll through the pages of a PDF document displayed in the PDF reader 732. The user can also add annotations to the PDF document or add shapes, lines, etc. to the PDF document. The technology disclosed therefore, allows the third-party elements to operate in active state while being rendered in a DOM plane below the canvas surface or canvas plane.

A further limitation of existing whiteboarding technologies is related to overlapping of multiple third-party elements with first-party elements rendered in the canvas. Existing whiteboarding systems do not allow interleaving rendering of third-party elements (such as DOM elements) with first-party elements such as annotations, shapes, sticky notes, lines, etc. For example, when in active mode, the third-party elements can be rendered on top of a first-party element in which they obstruct the content rendered in the first-party element. When in passive mode, existing whiteboarding systems can render a third-party element (or DOM element) below the first-party element on the canvas in which case the DOM element can be obstructed by the canvas element. Existing whiteboarding technologies do not allow interleaving of third-party elements between two or more canvas planes or canvas surfaces. Therefore, in existing whiteboarding systems the third-party elements are either rendered on top of the canvas element in which they obstruct the content rendered in the canvas element or they can be rendered below the canvas element in which case the third-party elements can be obstructed by first-party elements in the canvas plane.

In one implementation of the technology disclosed, two or more canvases can be stacked with their respective first-party elements rendered on respective canvases. The third-party elements can be interleaved between two or more canvases. Each of the plurality of canvases can have cutouts or cutout meshes corresponding to respective third-party elements. The technology disclosed allows stacking of two or more canvas planes and interleaving of rendering of third-party elements in between the two or more canvases. This is also referred to as a so-called lasagna model. The technology disclosed can include cutouts for third-party elements in the two or more canvases so that no matter how many third-party elements or canvases are stacked on top of a particular third-party element, a target third-party element is visible and accessible to a user in passive and active modes. The technology disclosed preserves the stacking order amongst various third-party elements and first-party elements, as described above. The technology disclosed provides the same visual effect, upon rendering, for third-party elements and first-party elements. Therefore, the users can easily navigate amongst various types of content and interact with the content without requiring the content to be re-rendered. The technology disclosed allows stacking of third-party elements and first-party elements in arbitrary ways. Therefore, the technology disclosed allows maintaining of an illusion that the third-party elements and the first-party elements are ordered and stacked and rendered on a same transparent surface.

By utilizing the rendering of third-party elements provided by the DOM plane (or any other rendering technology), the technology disclosed allows incorporation of a large variety of third-party elements (such as applications or other types of digital assets) in the whiteboarding session. In doing so, the technology disclosed utilizes the rendering logic of the third-party technologies such as HTML-based rendering provided by web browsers to render third-party elements. Therefore, the technology disclosed is able to quickly integrate various types of third-party elements into the whiteboarding system using the cutouts in canvas plane as described above.

The technology disclosed allows participants of a collaboration session to add first-party elements on the third-party elements rendered on the DOM plane and interleaved between multiple canvas planes. For example, the users can add comments or add annotations to the third-party elements. The first-party elements (such as annotations) can be linked to the specific geometric position on a third-party element, e.g., a particular position on the PDF reader window as defined by the coordinates. The PDF document itself can be scrolled through up and down based on pagination in the document. Therefore, the annotation in canvas can be linked to the third-party elements (such as DOM content) using a notion of stickiness. The technology disclosed can attach a note to a particular part of the third-party element (such as the DOM element) using geometry or position coordinates on the DOM element such as a PDF document.

As described above with reference to FIGS. 7A to 7D, the canvas can include non-cutout meshes corresponding to first-party elements (such as annotations, sticky notes, shapes, lines, connectors, etc.) and cutout meshes or cutouts corresponding to third-party elements. The technology disclosed includes logic to maintain a stacking order amongst all first-party and third-party elements using cutout meshes, as described above. The first-party elements are native to canvas that can be rendered for example using WebGL technology. The geometry (i.e., the shape), dimensions (i.e., size) and location of a cutout on the canvas matches the geometry, dimensions and location of a corresponding third-party element on the DOM plane which is positioned below the canvas. When the size and/or geometry of the third-party element changes, the size and/or geometry of the cutout is changed to match the updated size and/or geometry of the third-party element. When a user performs pan and/or zoom operations the positions of the cutouts do not need to be updated as their location remains at the same global coordinates (in world space) with respect to the position of corresponding third-party elements.

The technology disclosed includes logic to update the viewport to the workspace in response to pan and/or zoom operations. The notion of screen space of a digital display is basically a viewport on the infinite workspace (also referred to as the world space). The viewport is finite and is generated by rendering as many pixels as necessary to fill out the screen space. The technology disclosed includes data structures that keep record of positions of all first-party elements, third-party elements and cutouts in the workspace. When pan and/or zoom operations are performed, the world space positions of first-party elements, third-party elements and cutouts may not change but their screen space positions (on the viewport) may change. The technology disclosed includes logic to calculate the positions of first-party elements and third-party elements in response to pan and/or zoom operations when rendering them on the viewport using their respective world space positions. The technology disclosed can optimize the calculation of the positions of digital assets by not performing calculations for digital assets that may be out of the viewport.

### Synchronous and Asynchronous Review of Three-Dimensional Models in a Collaboration Session

Many implementations of the technology disclosed allow for participants to collaborate using a variety of collaboration models including asynchronous and synchronous collaboration sessions. In asynchronous collaboration sessions, the participants of a collaboration session can independently work on the same or different parts of the workspace. The participants can independently add, delete, edit or manipulate content or digital assets in the collaboration workspace. Some disclosed implementations include various features that allow participants of the collaboration session to identify what other participants are working on and the respective locations on the workspace at which other participants are working. For example, a presence awareness feature allows a participant to view the locations on the workspace at which other participants are interacting with the digital assets. The presence awareness feature can also allow a participant to view the locations on the workspace at which the generative AI model is being employed by another participant.

The synchronous collaboration sessions allow one participant to lead the collaboration session and other participants follow the leader (also referred to as the leading participant or the leading user) and view the actions or operations performed by the leader. In a leader-follower collaboration model, one participant acts as a leader of the collaboration session and other participants in the collaboration session follow the leader and view the same portion of the digital whiteboard (also referred to as a workspace, a virtual workspace, a collaboration workspace, a digital canvas, a display canvas and/or a canvas) that the leader is viewing or working on. The synchronous collaboration sessions can include presentation of content from one participant who acts as a leader of the collaboration session. In the leader-follower type of synchronous collaboration session, the technology disclosed matches viewports at display screens linked to computing devices of followers to viewport at display screen linked to leader's computing device. The leader-follower collaboration model allows the followers to view the same content on the workspace (or view a same portion of the workspace) as viewed by the leader on the display screen of her computing device. The synchronous collaboration sessions also comprise an automatic playback mode in which a digital asset such as a 3D model is automatically rotated or moved along a pre-defined path. The participants of the collaboration session view the playback of the 3D model. The automatic playback mode can include playback of video or other types of pre-defined presentations of content. All participants view the same content in the synchronous mode of collaboration. Further details of the leader-follower operations are presented in our U.S. application Ser. No. 15/147,576 (Atty. Docket No. HAWT 1019-2A), titled “Virtual Workspace Viewport Following in Collaboration Systems,” filed on May 5, 2016, now issued as U.S. Pat. No. 10,802,783, which is incorporated by reference and fully set forth herein. The details of the synchronized video playback are presented in our U.S. patent application Ser. No. 16/845,983 (Atty. Docket No. HAWT 1034-2), titled “Synchronous Video Content Collaboration Across Multiple Clients in a Distributed Collaboration System,” filed on Apr. 10, 2020, now issued as U.S. Pat. No. 11,178,446, which is fully incorporated into this application by reference.

Three-dimensional (3D) models are commonly used in product design and development. During the design and development process, the 3D models are reviewed by designers, engineers, product managers, etc. The technology disclosed provides a collaboration environment in which participants of a collaboration session can both (i) review 3D models and (ii) interact with 3D models by providing comments and annotations on 3D models. The disclosed interactive 3D model viewer can be used to view 3D model in a collaboration session. The 3D model player can also playback a pre-defined rotation or movement of a 3D model. During review of 3D models, the participants of the collaboration session may need to include their comments on various aspects of the 3D model. However, the 3D models are being played back in respective computing devices (also referred to as client nodes or client devices) of participants. The comments or annotations entered by one participant need to be visible to other participants in the collaboration session. Another technical challenge is that the 3D models are constructed in three-dimensional space whereas annotations and comments are presented in two-dimensional space. The disclosed 3D model player maps the two-dimensional plane on which comments and/or annotations are entered to three-dimensional points on the 3D model which is viewed in the three-dimensional space. In some implementations, the 3D models are constructed at least partially in dependence on the generative AI model. The modification and viewing of the 3D model, as well as its addition, positioning, or deletion from the workspace may also be performed at least in part using the generative AI model, as similarly described with reference to the AI-based generation of other types of digital assets or layouts of digital assets.

In one implementation, the technology disclosed enables a synchronous collaboration session in which the participants of the collaboration session can view a playback of the 3D model in which the 3D model is rotated along a pre-defined path. All participants view the playback of the 3D model in real time. A participant who is leading the collaboration session can pause the playback of the 3D model at any point during the playback of the model to facilitate discussion amongst the participants. The playback of the 3D model can be resumed after the participants review and discuss the displayed view of the 3D model.

In another implementation, the technology disclosed enables a synchronous collaboration session in which a leader rotates the 3D model and the followers view the 3D model in real time as the leader moves and/or rotates the 3D model. The leader can rotate the 3D model along any axis and at any desired pace (or speed). The leader can also pause the rotation and/or movement of the model at any point for discussion with followers and then resume movement and/or rotation of the 3D model.

In other implementations, the technology disclosed provides a so-called “drifting” feature that allows followers in a leader-follower collaboration session to drift away from the leader and work in an asynchronous manner. In a drift mode, the follower temporarily stops following the leader in the synchronous leader-follower collaboration session and can work independently on any digital assets in the workspace. This feature is useful if a follower wants to review a particular aspect or view of the 3D model in detail. The follower can drift away from the leader by performing a gesture such as moving a pointer device or by tapping on an interactive display or by selecting a user interface element, etc. After reviewing the 3D model independently, the follower can resume following the leader by selecting a user interface element. In one implementation, the follower automatically resumes following the leader after a pre-determined time such as 30 seconds, 1 minute, 2 minutes, etc. The collaboration server (also referred to as a server node) can provide a prompt to the follower asking if she would like to extend the duration of the drift mode session. The follower can select that option to continue working in drift mode. Otherwise, the collaboration server ends the drift mode for the follower at the end of the pre-determined time and the follower starts following the leader to view what the leader is presenting. In another implementation, the collaboration server ends the draft mode for the follower in response to an event in the spatial event map that is associated with an AI-assisted action.

In one implementation, the technology disclosed allows participants to comment and/or annotate on a 3D model. A user, participating in the collaboration session, can annotate on a portion of a 3D model or add comments related to a particular position on the 3D mode. During the collaboration session, when a user selects a point on the 3D model such as by interacting with the 3D model using a pointer (such as a mouse, laser pointer, etc.) or by touching the model on a touch-enabled display, the technology disclosed places an overlay on top of the 3D model to allows the user to enter comments or draw annotations. The overlay can be considered as a virtual layer positioned on the 3D model and can be invisible to the user. The overlay can capture the comments and annotations input by the participants. The overlay can be generated and updated at least partially using the generative AI model. The technology disclosed can associate an overlay layer with a particular point on the 3D model. The particular point represents a three-dimensional position on the 3D model. The three-dimensional position can be represented along x, y and z axes of a three-dimensional coordinate system. The technology disclosed includes logic to link the overlay layer which is in a two-dimensional space to a three-dimensional point, on the 3D model, at which the user interacted (or touched or selected). The technology disclosed can add a visual marker (such as a colored dot or another type of visual marker) to indicate that a comment or annotation has been added to the 3D model related to selected point on the 3D model. Various colors and/or shapes of visual markers can be used to distinguish between comments or annotation added by different users. The overlay layer can automatically become visible to users when the associated 3D point is positioned in a plane that is normal to the viewpoint of the users. In some cases, the overlay layer can become visible when vertical axis value of the associated 3D point is within a pre-defined range to a normal to the two-dimensional surface of the display. The predefined can range can be set as desired e.g., 5 degrees, 10 degrees or 15 degrees to the normal, etc. The overlay layer or virtual layer can become invisible as the 3D model is rotated and the position of the 3D point along is outside of the predefined range to the normal. The technology disclosed can link and save multiple overlay or virtual layers associated with respective 3D points on the three-dimensional model. Each overlay layer can include annotations and/or comments associated to a particular point on the 3D model. The technology disclosed can store the overlay layers including comments and/or annotations and positions of associated points on the 3D model.

In certain implementations, the technology disclosed allows users to enter ephemeral comments and/or ephemeral annotations related to a point on a 3D model. Ephemeral comments and/or ephemeral annotations are available for a pre-defined amount of time and afterwards these comments and annotations disappear. Ephemeral comments and ephemeral annotations are useful for collaboration and discussion amongst participants. Participants can enter their comments and annotate on a 3D model as desired. After a pre-defined amount of time or at the end of a collaboration session, the ephemeral comments and ephemeral annotations disappear and are not saved by the collaboration server. This feature helps in collaboration amongst participants but saves storage requirements as comments and annotations are not stored by the collaboration server. In one implementation, the collaboration system can provide an option to the user to either enter historical (or permanent) comments and/or historical annotations or to enter ephemeral comments and/or ephemeral annotations. Historical comments and historical annotations are stored in a storage location by the collaboration server. A user can also convert an ephemeral comment or an ephemeral annotation into a historical comment or a historical annotation by providing a gesture or by selecting a user interface element prior to disappearance of the ephemeral comment or the historical annotation from the display.

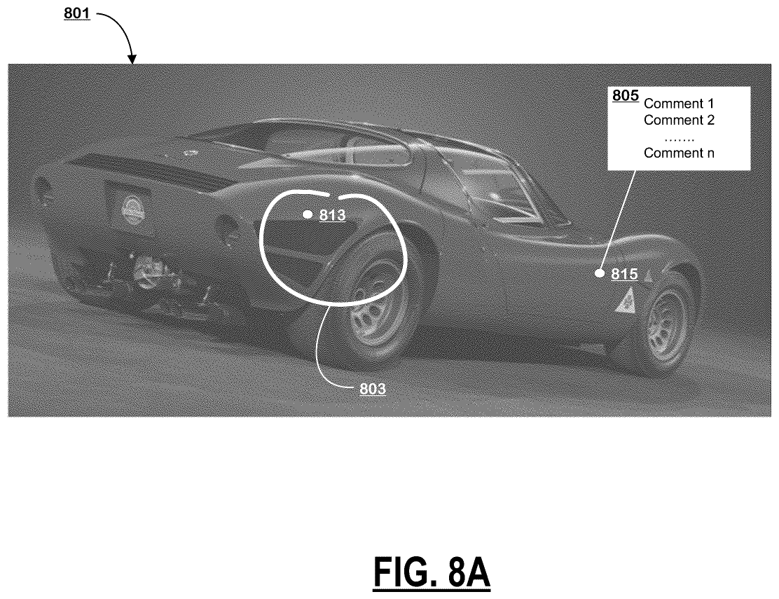

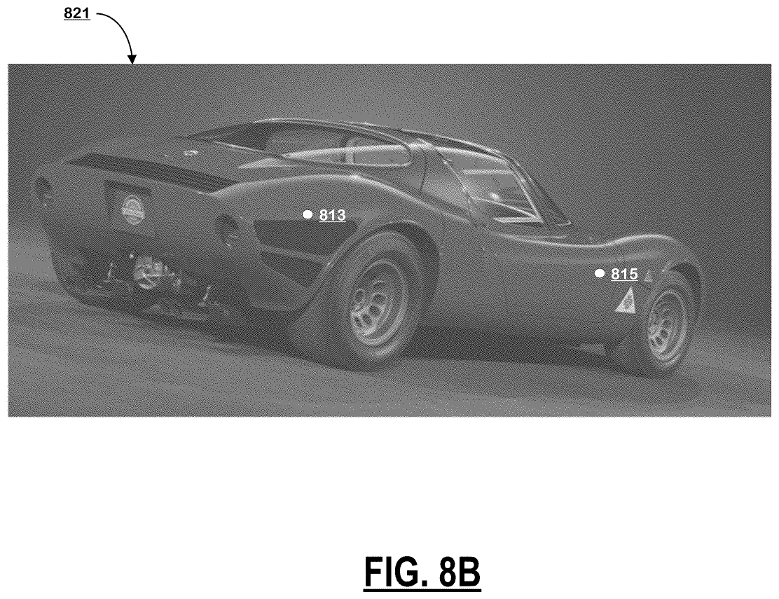

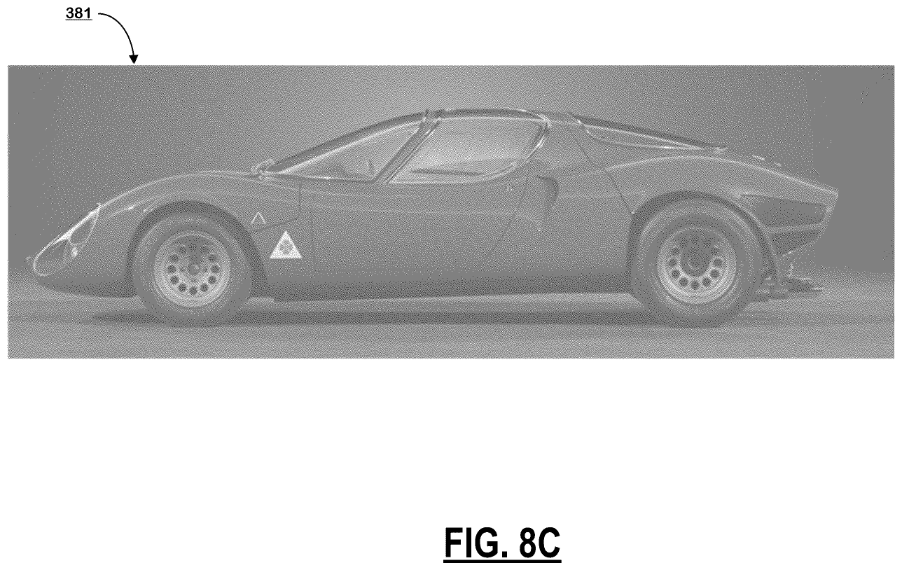

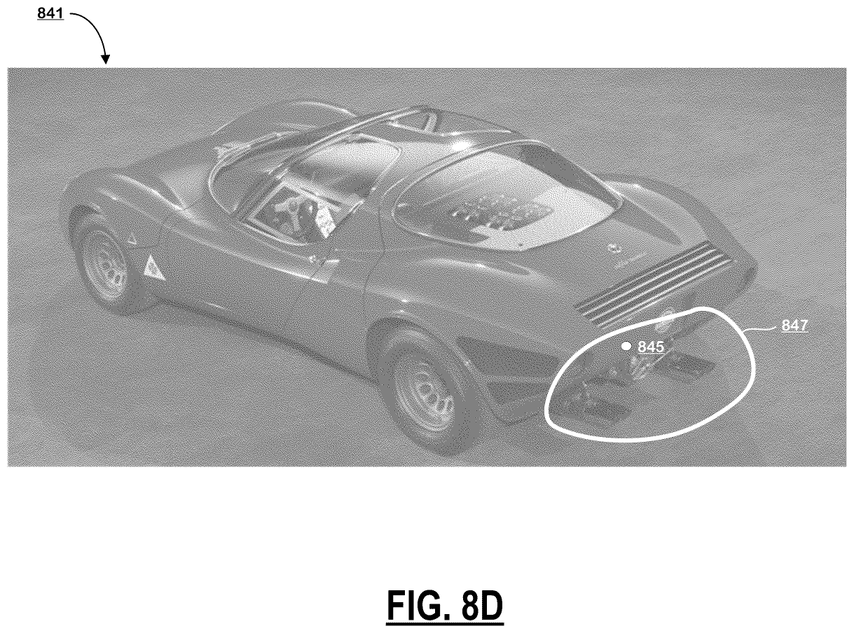

FIGS. 8A to 8D present an example of a three-dimensional model reviewed by participants in a collaboration session. The technology disclosed can access digital assets from third party DAM that store 3D models, databases and other forms of storage accessible to the collaboration server and/or the generative AI model, various files representing 3D models and aspects thereof, etc. The technology disclosed can also access and retrieve 3D models from proprietary digital asset management systems. In some cases, the one or more files that store the 3D models also include a pre-defined rotation for the 3D model. This pre-defined rotation defines a sequence of positions through which the 3D model is rotated. The pre-defined rotation includes a starting position of the model and then a series of positions along the x, y, and z coordinates at which the model is positions in sequential manner. Finally, the rotation of the 3D model is stopped at the ending position as defined in rotation of the 3D model. Examples of DAMs that store 3D models include <<www.sketchfab.com>>, <<www.3dart.it>>, etc. The example 3D model shown in FIGS. 8A to 8D is adapted from <<www.3dart.it/en/3d-car-free-model>>. The technology disclosed can display and rotate 3D models stored in a variety of formats such as STL (stereolithography), OBJ (object file), FBX (filmbox), COLLADA (collaborative design activity), AMF (additive manufacturing file format), 3DS (3D studio file), etc.

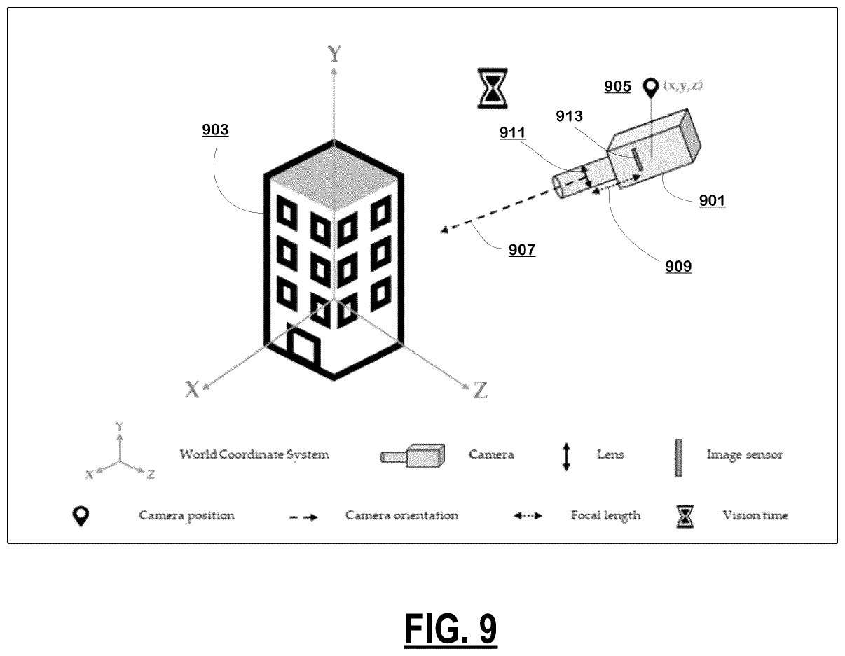

Visualizing a 3D object located in a three-dimensional space (x, y, z) requires a virtual camera. The virtual camera converts the light reflected from the 3D object into an image of that object and projects the image on a surface. FIG. 9 illustrates a virtual camera 901 placed in a three-dimensional space to view a 3D object 903. To generate a 3D viewpoint of an object in a three-dimensional space, the camera parameters including camera position (805), orientation (807) and focal length (809) are provided to client nodes along with a 3D model. The camera position and orientation are 3D vectors that, respectively represent a 3D location of camera and a 3D viewing direction into the three-dimensional coordinate system (also referred to as world coordinate system). The focal length is the distance between the projection center (or optical center) and the projection plane. In FIG. 9, the projection center is represented by the position of the lens 911 and the projection plane is represented by the position of the image sensor 913. Focal length defines angle of view, i.e., how much of the 3D view will be captured by the camera. In case of a predefined playback (or an animation) of the 3D model, a vision time can be given to a 3D viewpoint. The vision time is defined as the time spent on visualization a given viewpoint. The vision time identifies how much time a particular view of the 3D model is presented to the user before the model rotates to a next position of the 3D model. Further details of camera parameters are presented in, Billen et al. 2019, “3D viewpoint management and navigation in urban planning: Application to the exploratory phase”, published in the Journal of Remote Sensing, 11, no. 3:236. The article is available online at <<www.mdpi.com/2072-4292/11/3/236>>. An example of viewing a 3D model in a collaboration workspace is presented below with reference to FIGS. 8A to 8D. FIG. 9 is adapted from Billen et al. 2019.

FIG. 8A shows a first view of the 3D model in a user interface 801. The 3D video player can playback the 3D model on a pre-defined rotation or a pre-defined path. A user (e.g., who is leading the collaboration session) can also manually rotate the 3D model and pause the rotation at any given point to review the model with other participants in the collaboration session. FIG. 8A shows that one or more users in the collaboration session have entered comments (805) and annotation (803). When a user interacts with the 3D model such as by selecting the 3D model using a pointer (e.g., a mouse, a laser pointer, etc.) or by touching the model on a touch-enabled display, the 3D model player places an overlay layer on the 3D model to receive inputs (such as comments and annotations) from users. FIG. 8A shows two such points 813 and 815 on the 3D model. A user selected a position (corresponding to point 813) on the model to enter the annotation (803). The 3D model player marks that selected point on the model with a marker (813) and placed an overlay layer on the model to allow the user to enter the annotation (803). Similarly, when a user selected a position on the model (corresponding to point 815) the 3D player marked a point 815 on the selected position and placed a marker 815 on the 3D model.

FIG. 8B presents an illustration 821 displaying the markers 813 and 815 are displayed on the 3D model to indicate to the users that annotations and/or comments have previously been entered by users and can be viewed by selecting the respective marker. In some cases, different colors and/or shapes of markers to indicate whether a marker represents an annotation or a comment. Different colors and/or shapes of markers can be used to different between comments and/or annotations entered by different users. Markers can also include labels to indicate the name of the user who entered the comments or provide some other information about the comment and/or annotation such as date and/or time when the comment was entered, etc. The 3D model player includes logic to link the comments and annotations to the 3D model and store the comments and annotations with the 3D model in a database. The 3D model player also includes logic to store positions (or locations) at which the comments are added. Additionally, the 3D model player includes logic to store the overlay layers on which respective comments and annotations are placed. The annotations, comments and overlay layers are stored as digital assets along with other collaboration data related to the workspace. The 3D model player includes logic to access the digital assets related to a 3D model when the 3D model is displayed on the workspace. The 3D model player includes logic to display the comments and/or annotations that are previously entered by the users related to various points on the 3D model as the 3D model is rotated on the display screen. During rotation of a 3D model, when an overlay layer on which comments and/or annotation have been entered by users becomes parallel to the display screen or display surface, the comments and/or annotations can become visible. In one implementation, markers representing the comments and/or annotations on an overlay layer become visible when the overlay layer becomes parallel to (or some other range of being close enough to parallel) the display screen or the display surface. The user can select a marker to view the comments and/or annotations. The user can also add new comments or new annotations. In one implementation, a meeting organizer or a meeting leader can also edit comments and/or annotations entered by other users.

FIG. 8C presents a view 831 of the 3D model shown in FIGS. 8A and 8B. The 3D model can be rotated and viewed in any direction in the three-dimensional space. As illustrated, markers 813 and 815 are not visible because they are not parallel (or close enough to parallel) to the display screen or display surface as viewed by a user.

FIG. 8D presents a view 841 of the 3D model of FIGS. 8A, 8B and 8C. A user has selected a point on the 3D model. The 3D model player creates a marker 845 to indicate the position (or location) on the model that is selected by user. The 3D model player places an overlay layer on top of the view 841 of the 3D model. The user enters an annotation 847 as shown in FIG. 8D.

### Particular Implementations

One method disclosed comprises sending, from a server node, at least a portion of a spatial event map that locates events in a virtual workspace at a client node in a plurality of client nodes, the spatial event map comprising a specification of a dimensional location of a viewport in the virtual workspace. The method also comprises sending, from the server node, data to allow the client node to display, in a screen space of a display associated with the client node, a digital asset identified by events in the spatial event map that are associated with locations within a viewport of the client node, and receiving, from the client node, an input for a trained machine learning model wherein the input comprises (i) the identification of a digital asset selected by a user or (ii) a prompt wherein the prompt is a text-based or a voice-based description of desired features in an AI-based digital asset. The method also comprises sending, from the server node, the first input received from the client node to the trained machine learning model, and receiving, at the server node, the AI-based digital asset as output by the trained machine learning model. The method also comprises sending, from the server node, the AI-based digital asset to the plurality of client nodes, allowing the client nodes to display the AI-based digital asset in respective digital displays linked to the plurality of client nodes.

In some implementations, wherein the trained machine learning model is trained to generate, as output, the AI-based digital asset in dependence upon at least one of a similarity of the identified digital asset and the AI-based digital asset, such that the trained machine learning model is trained to maximize the similarity of a model input and a model output, and a match between a feature of the AI-based digital asset and one or more of the desired features within a prompt. In another implementation, the AI-based digital asset is generated in dependence upon one or more digital assets within a digital asset storage accessible to the trained learning model. In certain implementations, the trained machine learning model identifies and extracts a preexisting digital asset from the digital asset storage for use as the AI-based digital asset. Alternatively, the trained machine learning model can identify one or more digital assets from the digital asset storage and generates the AI-based digital asset with similar features to the one or more identified digital assets from the digital asset storage.

One disclosed method includes receiving, from the client node, a feedback input for the trained machine learning model wherein the feedback input comprises an identification of another digital asset selected by the user or a feedback prompt wherein the feedback prompt is a text-based or a voice-based description of desired features in a refined AI-based digital asset. The method also includes sending, from the server node, the feedback input received from the client node to the trained machine learning model. The server node receives the refined AI-based digital asset as output by the trained machine learning model, wherein the refined AI-based digital asset is an updated version of the AI-based digital asset based on the feedback input.

Another disclosed method includes sending, from the server node, at least a portion of the spatial event map identifying the events in the virtual workspace. The particular event associated with the AI-based digital asset comprises data specifying virtual coordinates within the virtual workspace of the AI-based digital asset; data specifying at least one of a parameter and an input of the trained machine learning model associated with generating the AI-based digital asset; data identifying a time of the particular event; and data identifying an action including at least one of a generation, an update, and a deletion of the AI-based digital asset within the virtual workspace.

The AI-based digital asset can be a text element, a graphical element, an uploaded file, a programmable window of a third-party application, a webpage, or a three-dimensional model. In some implementations, the trained machine learning model generates the AI-based digital asset in further dependence upon an Internet-based data source. In other implementations, the AI-based digital asset is stored in a training database for later use in subsequent training of a machine learning model.

Some implementations of the technology disclosed include receiving, from the client node, another input for the trained machine learning model wherein the other input comprises (i) the identification of the digital asset selected by a user or (ii) another prompt wherein the other prompt is a text-based or voice-based description of desired features in an AI-based layout of a plurality of digital assets. The plurality of digital assets of the AI-based layout can be selected and arranged based on at least one of a similarity of the identified digital asset and a particular digital asset of the plurality of digital assets, such that the trained machine learning model is trained to maximize the similarity of a model input and a model output, and a match between a feature of the AI-based digital asset and one or more of the desired features within a prompt.

In one implementation, a feedback input for the trained machine learning model is received from the client node. The feedback input comprises (i) an identification of another digital asset selected by the user or (ii) a feedback prompt wherein the feedback prompt is a text-based or a voice-based description of desired features in a refined AI-based digital asset. The server node sends the feedback input received from the client node to the trained machine learning model and receives the refined AI-based digital asset as output by the trained machine learning model, wherein the refined AI-based digital asset is an updated version of the AI-based digital asset based on the feedback input.

Many implementations further include sending, from the server node, at least a portion of the spatial event map identifying the events in the virtual workspace. An event identifying a particular event associated with a digital asset of the plurality of digital assets comprises data specifying virtual coordinates within the virtual workspace of the digital asset; data specifying at least one of a parameter and an input of the trained machine learning model associated with generating or arranging of the digital asset; data identifying a time of the particular event; and data identifying an action including at least one of a generation, an update, and a deletion of the digital asset within the virtual workspace.

One disclosed method includes receiving, from the client node, another input for the trained machine learning model wherein the other input comprises (i) the identification of the digital asset selected by a user or (ii) another prompt wherein the other prompt is a text-based or voice-based description of desired features in an AI-based layout of a plurality of digital assets. The plurality of digital assets of the AI-based layout can be selected and arranged within the AI-based layout based on at least one of a similarity of the identified digital asset and a particular digital asset of the plurality of digital assets, such that the trained machine learning model is trained to maximize the similarity of a model input and a model output, and a match between a feature of the AI-based digital asset and one or more of the desired features within a prompt.

Other implementations include receiving, from the client node, a feedback input for the trained machine learning model wherein the feedback input comprises (i) an identification of another digital asset selected by the user or (ii) a feedback prompt wherein the feedback prompt is a text-based or a voice-based description of desired features in a refined AI-based digital asset. After receiving the feedback input, the server node can send the feedback input received from the client node to the trained machine learning model and receive the refined AI-based digital asset as output by the trained machine learning model, wherein the refined AI-based digital asset is an updated version of the AI-based digital asset based on the feedback input.

Another disclosed method comprises receiving, at a client node, at least a portion of a spatial event map that locates events in a virtual workspace at the client node, the spatial event map comprising a specification of a dimensional location of a viewport in the virtual workspace, receiving, at a client node, data to allow the client node to display, in a screen space of a display associated with the client node, a digital asset identified by events in the spatial event map that are associated with locations within a viewport of the client node; sending, to a server node, an input for a trained machine learning model wherein the input comprises (i) the identification of a digital asset selected by a user and or (ii) a prompt wherein the prompt is a text-based and/or a voice-based description of desired features in an AI-based digital asset; and receiving, at the client node, the AI-based image digital asset to the plurality of client nodes, allowing the client nodes to display the AI-based image digital asset in respective digital displays linked to the plurality of client nodes.

One implementation includes a server node comprising a processor configured with logic to implement operations including sending, from a server node, at least a portion of a spatial event map that locates events in a virtual workspace at a client node in a plurality of client nodes, the spatial event map comprising a specification of a dimensional location of a viewport in the virtual workspace; sending, from the server node, data to allow the client node to display, in a screen space of a display associated with the client node, a digital asset identified by events in the spatial event map that are associated with locations within a viewport of the client node; receiving, from the client node, an input for a trained machine learning model wherein the input comprises (i) the identification of a digital asset selected by a user or (ii) a prompt wherein the prompt is a text-based or a voice-based description of desired features in an AI-based digital asset; sending, from the server node, the first input received from the client node to the trained machine learning model; receiving, at the server node, the AI-based digital asset as output by the trained machine learning model; and sending, from the server node, the AI-based digital asset to the plurality of client nodes, allowing the client nodes to display the AI-based digital asset in respective digital displays linked to the plurality of client nodes.

Another implementation includes a client node comprising a processor configured with logic to implement operations comprising receiving, at a client node, at least a portion of a spatial event map that locates events in a virtual workspace at the client node, the spatial event map comprising a specification of a dimensional location of a viewport in the virtual workspace; receiving, at a client node, data to allow the client node to display, in a screen space of a display associated with the client node, a digital asset identified by events in the spatial event map that are associated with locations within a viewport of the client node; sending, to a server node, an input for a trained machine learning model wherein the input comprises (i) the identification of a digital asset selected by a user and or (ii) a prompt wherein the prompt is a text-based and/or a voice-based description of desired features in an AI-based digital asset; and receiving, at the client node, the AI-based image digital asset to the plurality of client nodes, allowing the client nodes to display the AI-based image digital asset in respective digital displays linked to the plurality of client nodes.

Other implementations of the methods described in this section can include a tangible non-transitory computer-readable storage medium storing program instructions loaded into memory that, when executed on processors cause the processors to perform any of the methods described above. Yet another implementation of the methods described in this section can include a device including memory and one or more processors operable to execute computer instructions, stored in the memory, to perform any of the methods described above.

Any data structures and code described or referenced above are stored according to many implementations on a computer readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the technology disclosed and the scope of the following claims. It is contemplated that technologies described herein can be implemented using collaboration data structures other that the spatial event map.

What is claimed is:

1. A method comprising:
sending, from a server node, at least a portion of a spatial event map that locates events in a virtual workspace at a client node in a plurality of client nodes, the spatial event map comprising a specification of a dimensional location of a viewport in the virtual workspace;
sending, from the server node, data to allow the client node to display, in a screen space of a display associated with the client node, a digital asset identified by events in the spatial event map that are associated with locations within a viewport of the client node;
receiving, from the client node, an input for a trained machine learning model wherein the input comprises (i) the identification of a digital asset selected by a user or (ii) a prompt wherein the prompt is a text-based or a voice-based description of desired features in an artificial intelligence (AI)-based digital asset;
sending, from the server node, the input received from the client node to the trained machine learning model;
receiving, at the server node, the AI-based digital asset as output by the trained machine learning model; and
sending, from the server node, the AI-based digital asset to the plurality of client nodes, allowing the client nodes to display the AI-based digital asset in respective digital displays linked to the plurality of client nodes.

2. The method of claim 1, wherein the trained machine learning model is trained to generate, as output, the AI-based digital asset in dependence upon at least one of:
a similarity of the identified digital asset and the AI-based digital asset, such that the trained machine learning model is trained to maximize the similarity of a model input and a model output; and
a match between a feature of the AI-based digital asset and one or more of the desired features within a prompt.

3. The method of claim 1, wherein the AI-based digital asset is generated in dependence upon one or more digital assets within a digital asset storage accessible to the trained learning model.

4. The method of claim 3, wherein the trained machine learning model identifies and extracts a preexisting digital asset from the digital asset storage for use as the AI-based digital asset.

5. The method of claim 3, wherein the trained machine learning model identifies one or more digital assets from the digital asset storage and generates the AI-based digital asset with features in dependence on the one or more identified digital assets from the digital asset storage.

6. The method of claim 1, further including:
receiving, from the client node, a feedback input for the trained machine learning model wherein the feedback input comprises (i) an identification of another digital asset selected by the user or (ii) a feedback prompt wherein the feedback prompt is a text-based or a voice-based description of desired features in a refined AI-based digital asset;
sending, from the server node, the feedback input received from the client node to the trained machine learning model; and
receiving, at the server node, the refined AI-based digital asset as output by the trained machine learning model, wherein the refined AI-based digital asset is an updated version of the AI-based digital asset based on the feedback input.

7. The method of claim 1, further including sending, from the server node, at least a portion of the spatial event map identifying the events in the virtual workspace, wherein a particular event associated with the AI-based digital asset comprises:
data specifying virtual coordinates within the virtual workspace of the AI-based digital asset;
data specifying at least one of a parameter and an input of the trained machine learning model associated with generating the AI-based digital asset;
data identifying a time of the particular event; and
data identifying an action including at least one of a generation, an update, and a deletion of the AI-based digital asset within the virtual workspace.

8. The method of claim 1, wherein the AI-based digital asset is a text element, a graphical element, an uploaded file, a programmable window of a third-party application, a webpage, or a three-dimensional model.

9. The method of claim 1, wherein the trained machine learning model generates the AI-based digital asset in further dependence upon an Internet-based data source.

10. The method of claim 1, wherein the AI-based digital asset is stored in a training database for later use in subsequent training of a machine learning model.

11. The method of claim 1, further including receiving, from the client node, another input for the trained machine learning model wherein the other input comprises (i) the identification of the digital asset selected by a user or (ii) another prompt wherein the other prompt is a text-based or voice-based description of desired features in an AI-based layout of a plurality of digital assets.

12. The method of claim 11, wherein the plurality of digital assets of the AI-based layout are selected and arranged within the AI-based layout based on at least one of:
a similarity of the identified digital asset and a particular digital asset of the plurality of digital assets, such that the trained machine learning model is trained to maximize the similarity of a model input and a model output; and
a match between a feature of the AI-based digital asset and one or more of the desired features within a prompt.

13. The method of claim 11, further including:
receiving, from the client node, a feedback input for the trained machine learning model wherein the feedback input comprises (i) an identification of another digital asset selected by the user or (ii) a feedback prompt wherein the feedback prompt is a text-based or a voice-based description of desired features in a refined AI-based digital asset;
sending, from the server node, the feedback input received from the client node to the trained machine learning model; and
receiving, at the server node, the refined AI-based digital asset as output by the trained machine learning model, wherein the refined AI-based digital asset is an updated version of the AI-based digital asset based on the feedback input.

14. The method of claim 11, further including sending, from the server node, at least a portion of the spatial event map identifying the events in the virtual workspace, wherein an event identifying a particular event associated with a digital asset of the plurality of digital assets comprises:
data specifying virtual coordinates within the virtual workspace of the digital asset;
data specifying at least one of a parameter and an input of the trained machine learning model associated with generating or arranging of the digital asset;
data identifying a time of the particular event; and
data identifying an action including at least one of a generation, an update, and a deletion of the digital asset within the virtual workspace.

15. A method comprising:
receiving, at a client node, at least a portion of a spatial event map that locates events in a virtual workspace at the client node, the spatial event map comprising a specification of a dimensional location of a viewport in the virtual workspace;
receiving, at a client node, data to allow the client node to display, in a screen space of a display associated with the client node, a digital asset identified by events in the spatial event map that are associated with locations within a viewport of the client node;
sending, to a server node, an input for a trained machine learning model wherein the input comprises (i) the identification of a digital asset selected by a user and or (ii) a prompt wherein the prompt is a text-based and/or a voice-based description of desired features in an artificial intelligence (AI)-based digital asset; and
receiving, at the client node, the AI-based digital asset, allowing the client node to display the AI-based digital asset in a digital display linked to the client node.

16. The method of claim 15, further including receiving, at the client node, at least a portion of the spatial event map identifying the events in the virtual workspace, wherein a particular event associated with the AI-based digital asset comprises:
data specifying virtual coordinates within the virtual workspace of the AI-based digital asset;
data specifying at least one of a parameter and an input of the trained machine learning model associated with generating the AI-based digital asset;
data identifying a time of the particular event; and
data identifying an action including at least one of a generation, an update, and a deletion of the AI-based digital asset within the virtual workspace.

17. A server node, the server node comprising:
a processor configured with logic to implement operations comprising:
sending, from a server node, at least a portion of a spatial event map that locates events in a virtual workspace at a client node in a plurality of client nodes, the spatial event map comprising a specification of a dimensional location of a viewport in the virtual workspace;
sending, from the server node, data to allow the client node to display, in a screen space of a display associated with the client node, a digital asset identified by events in the spatial event map that are associated with locations within a viewport of the client node;
receiving, from the client node, an input for a trained machine learning model wherein the input comprises (i) the identification of a digital asset selected by a user or (ii) a prompt wherein the prompt is a text-based or a voice-based description of desired features in an artificial intelligence (AI)-based digital asset;
sending, from the server node, the input received from the client node to the trained machine learning model;
receiving, at the server node, the AI-based digital asset as output by the trained machine learning model; and
sending, from the server node, the AI-based digital asset to the plurality of client nodes, allowing the client nodes to display the AI-based digital asset in a digital display linked to the client node.

18. A non-transitory computer-readable recording medium having a program recorded thereon, the program, when executed by a server node including a processor, causing the server node to perform the operations of claim 1.

19. A non-transitory computer-readable recording medium having a program recorded thereon, the program, when executed by a client node including a processor, causing the client node to perform the operations of claim 15.
